(19) United States
(12) Patent Application Publication
(10) Pub. No.: US 2025/0299094 A1
(43) Pub. Date: Sep. 25, 2025

(54) EVALUATING LABELED SENSOR REPRESENTATIONS FOR MACHINE LEARNING SYSTEMS AND APPLICATIONS

(71) Applicant: NVIDIA Corporation, Santa Clara, CA (US)

(72) Inventors: James Skinner, Arvada, CO (US); Kartik Garg, Chicago, IL (US); Yongxi Hou, Pleasanton, CA (US); Adam Vafaei, Milpitas, CA (US); Tian Xia, Scarsdale, NY (US); Tilman Wekel, San Jose, CA (US)

(21) Appl. No.: 18/615,835

(22) Filed: Mar. 25, 2024

(51) Int. Cl. G06N 20/00

(52) U.S. Cl. CPC G06N 20/00

(57) ABSTRACT

In various examples, evaluating labeled training data for machine learning systems and applications is described herein. Systems and methods described herein may determine whether labels for training data are accurate based at least on additional labels for the training data that represent a consensus of how the training data should be labeled. For instance, sensor representations (e.g., images, point clouds, etc.) may initially be labeled using one or more automatic techniques (e.g., one or more machine learning models, one or more neural networks, one or more algorithms, etc.) and then verified and/or updated by users to generate first labels for the sensor representations. Additionally, copies of the sensor representations may also be labeled using additional users to generate second labels, where these second labels are then used to generate the consensus labels for the sensor representations. The consensus labels may then be used to evaluate the first labels.

### BACKGROUND

Labeling sensor data may be important for many applications, such as to generate training data that is later used to train machine learning models to perform specific tasks (e.g., object or feature recognition, object or feature tracking, object or feature classification, trajectory planning, etc.). As such, conventional systems may use one or more machine learning models to determine initial labels for objects depicted by images represented by the sensor data. Next, in order to verify that the labeled sensor data is accurate enough for use as training data, users (e.g., labelers) may then review at least a portion of the images to verify the initial labels that are accurate and/or update the initial labels that are inaccurate. However, even by having these users manually verify and/or update the initial labels, at least a portion of the labels may still be inaccurate based on user error. For example, the users may also wrongfully label images, such as by relying too much on the initial labels, by not fully understand instructions on how to label the images, and/or by receiving instructions that do not adequately describe how labeling should be performed.

Additionally, if these errors are not corrected before generating training data that includes the labeled sensor data, the training data may be inadequate for its intended purpose, such as training a machine learning model. For example, based on the purpose for which the machine learning model is being used, such as with regard to autonomous driving of vehicles, the machine learning model may include product requirements indicating an accuracy that the machine learning model must satisfy. However, if the machine learning model is trained using training data that includes a number of errors, then the machine learning model may not satisfy the product requirements after training. In some circumstances, this may delay the training of the machine learning model and/or require that additional training data be generated for performing additional training of the machine learning model.

### SUMMARY

Embodiments of the present disclosure relate to evaluating labeled training data for machine learning systems and applications. Systems and methods, such as those described herein, may determine whether labels for training data are accurate based at least on additional labels for the training data that represent a consensus of how the training data should be labeled. For instance, sensor representations (e.g., images, point clouds, etc.) may initially be labeled using one or more automatic techniques (e.g., one or more machine learning models, one or more neural networks, one or more algorithms, etc.) and then verified and/or updated by users to generate first labels for the sensor representations. Additionally, copies of the sensor representations may also be labeled using additional users to generate second labels, where these second labels are then used to generate the consensus labels for the sensor representations. The consensus labels may then be used to evaluate the first labels, such as by determining one or more values for one or more metrics that measure an accuracy of the first labels, determining scores for the users that reviewed the initial labels, and/or determine scores associated with the training data that includes the sensor representations labeled with the first labels.

In contrast to conventional systems, such as those described above, the systems of the present disclosure use the consensus labels to determine accuracies of the users and/or the labels of the training data. This way, the systems of the present disclosure are further to determine where errors are occurring with regard to labeling the training data, cause additional training for users that are not accurately labeling the training data, and/or further update the labels of the training data if needed. Additionally, by performing such processes, the systems of the current disclosure may also generate training data that is verified as including accuracies that satisfy product requirements for training machine learning models, such as based on the product requirements that specify how accurate the labels of the training data need to be in order to use the training data to train the machine learning models.

### BRIEF DESCRIPTION OF THE DRAWINGS

The present systems and methods for evaluating labeled training data for machine learning systems and applications are described in detail below with reference to the attached drawing figures, wherein:

FIG. 1 illustrates an example data flow diagram for a process of evaluating labels associated with training data, in accordance with some embodiments of the present disclosure;

FIG. 2 illustrates an example of copies of a sensor representation that may be labeled using a number of users, in accordance with some embodiments of the present disclosure;

FIG. 3 illustrates an example of processing sensor data to determine initial labels for objects represented by a sensor representation, in accordance with some embodiments of the present disclosure;

FIG. 4 illustrates an example of users reviewing initial labels for a sensor representation, in accordance with some embodiments of the present disclosure;

FIG. 5 illustrates an example of users labeling a sensor representation, in accordance with some embodiments of the present disclosure;

FIG. 6 illustrates an example of generating a consensus label associated with an object represented by a sensor representation, in accordance with some embodiments of the present disclosure;

FIG. 7 illustrates an example of using a consensus label to evaluate labels associated with a sensor representation, in accordance with some embodiments of the present disclosure;

FIG. 8 illustrates an example of determining whether training data satisfies one or more product requirements, in accordance with some embodiments of the present disclosure;

FIG. 9 illustrates a data flow diagram illustrating a process for training one or more machine learning models to perform one or more tasks, in accordance with some embodiments of the present disclosure;

FIG. 10 illustrates a flow diagram showing a method for evaluating labels associated with sensor representations, in accordance with some embodiments of the present disclosure;

FIG. 11 illustrates a flow diagram showing a method for evaluating training data to determine whether the training data is satisfactory for training one or more machine learning models, in accordance with some embodiments of the present disclosure;

FIG. 12A is an illustration of an example autonomous vehicle, in accordance with some embodiments of the present disclosure;

FIG. 12B is an example of camera locations and fields of view for the example autonomous vehicle of FIG. 12A, in accordance with some embodiments of the present disclosure;

FIG. 12C is a block diagram of an example system architecture for the example autonomous vehicle of FIG. 12A, in accordance with some embodiments of the present disclosure;

FIG. 12D is a system diagram for communication between cloud-based server(s) and the example autonomous vehicle of FIG. 12A, in accordance with some embodiments of the present disclosure;

FIG. 13 is a block diagram of an example computing device suitable for use in implementing some embodiments of the present disclosure; and

FIG. 14 is a block diagram of an example data center suitable for use in implementing some embodiments of the present disclosure.

### DETAILED DESCRIPTION

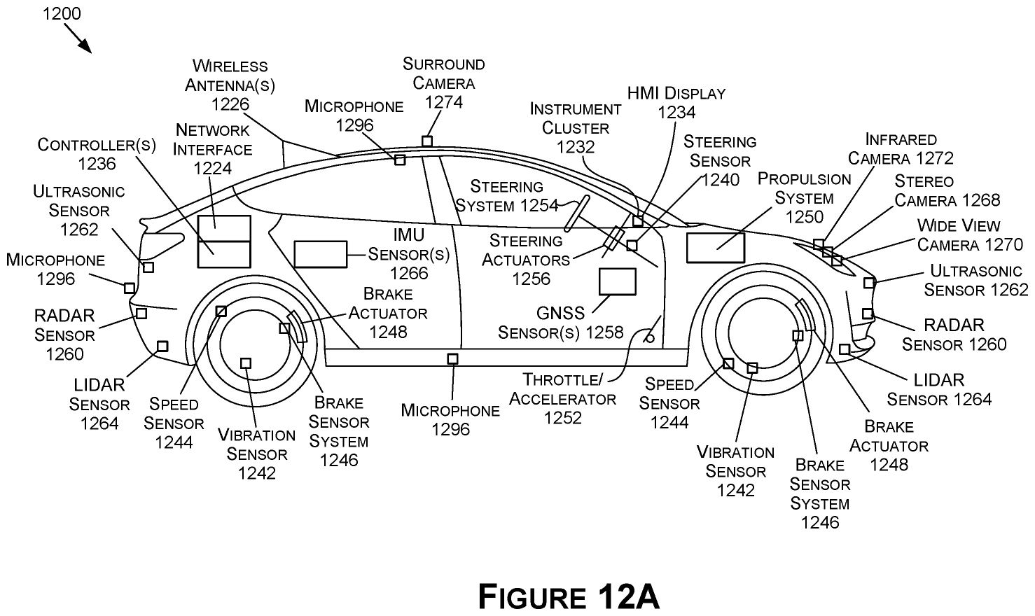

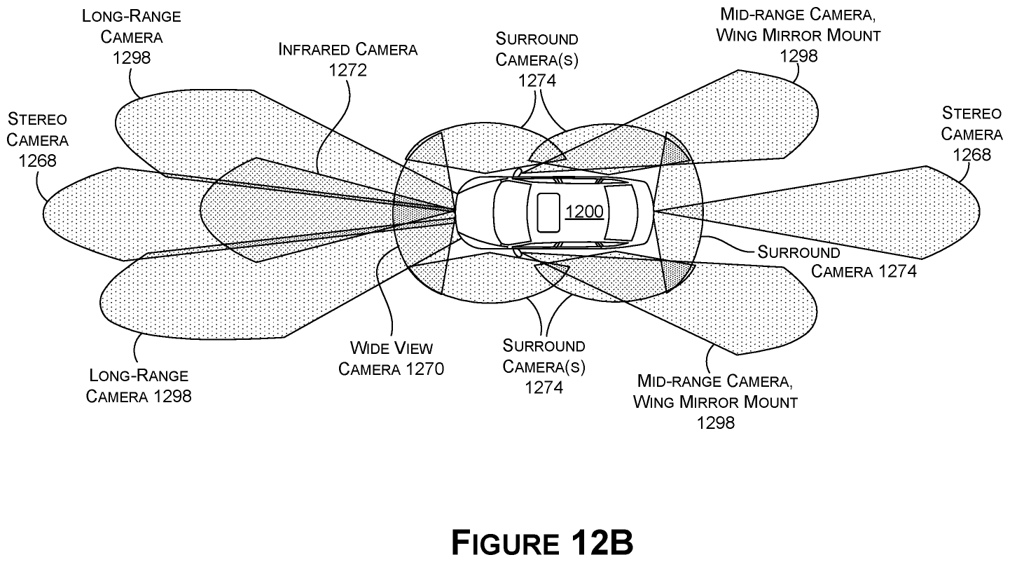

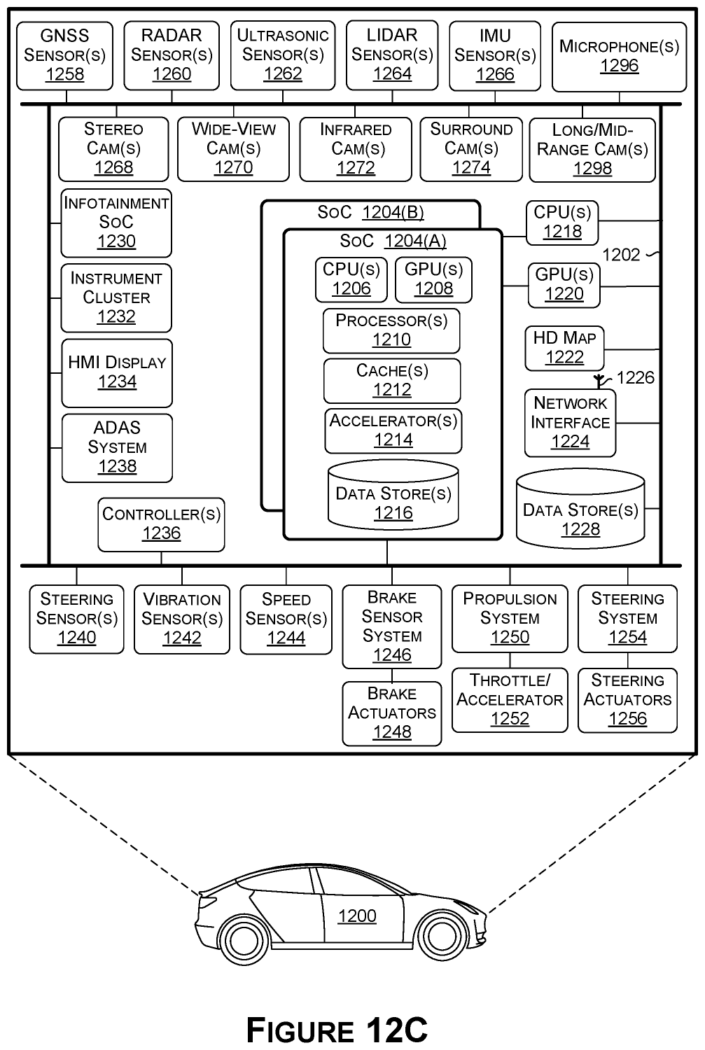

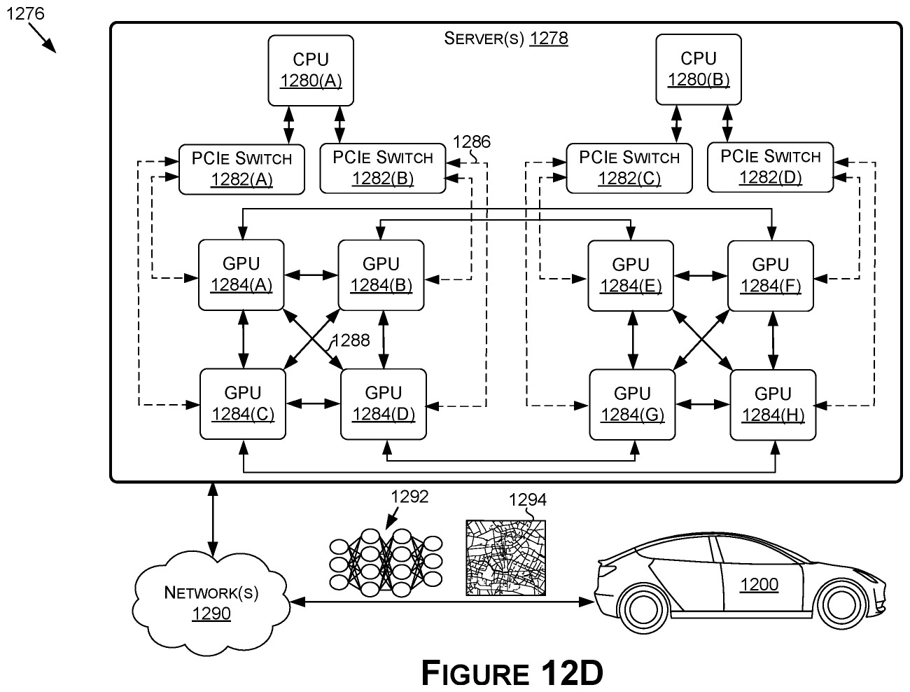

Systems and methods are disclosed related to evaluating labeled training data for machine learning systems and applications. Although the present disclosure may be described with respect to an example autonomous or semi-autonomous vehicle or machine 1200 (alternatively referred to herein as “vehicle 1200,” “ego-vehicle 1200,” “ego-machine 1200,” or “machine 1200,” an example of which is described with respect to FIGS. 12A-12D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to labeling training data, this is not intended to be limiting, and the systems and methods described herein may be used in augmented reality, virtual reality, mixed reality, robotics, security and surveillance, autonomous or semi-autonomous machine applications, and/or any other technology spaces where object detection and/or map creation may be used.

For instance, a system(s) may receive sensor data generated using one or more sensors, such as one or more sensors of one or more machines navigating within one or more environments. As described herein, the sensor data may include, but is not limited to, image data generated using one or more image sensors (e.g., one or more cameras), LiDAR data generated using one or more LiDAR sensors, RADAR data generated using one or more RADAR sensors, and/or any other type of sensor data generated using any other type of sensor. Additionally, the sensor data may represent sensor representations, such as camera images, LiDAR images, LiDAR point clouds, and/or any other type of sensor representations that further represent one or more objects located within the environment. As described herein, an object may include, but is not limited to, a vehicle (e.g., a car, a bus, a van, motorcycle, etc.), a pedestrian, an animal, a traffic feature (e.g., a traffic signal, a traffic sign, a road marking, a curb, etc.), a structure, and/or any other type of object that may be located within the environment(s). Although described with respect to automotive or robotics use cases, the system and methods described herein may be used with any labeling or annotation platform in any industry or technology space.

The system(s) may then process the sensor data using one or more automatic labeling techniques in order to determine labels (referred to, in some examples, as “initial labels” and/or “automatically generated labels) for sensor representations (referred to, in some examples, as “first sensor representations”). For instance, the system(s) may process the sensor data using one or more machine learning models, one or more neural networks, one or more algorithms, one or more modules, and/or any other component that is configured to perform object detection, object tracking, object recognition, and/or any other processing techniques. As described herein, a label for a sensor representation may indicate a location of an object as represented by the sensor representation. For example, the label may include a two-dimensional (2D) bounding shape and/or a three-dimensional (3D) bounding shape, such as a bounding box, a bounding cuboid, a bounding pentagon, a bounding hexagon, a bounding heptagon, and/or any other shape. Additionally, in some examples, a label may include additional information associated with the object, such as a classification associated with the object.

The system(s) may then provide the first sensor representations as labeled with the initial labels to one or more first client devices for review by one or more first users (e.g., one or more first labelers). For instance, and for a first sensor representation, a first client device may display the first sensor representation to a first user. The first user may then review one or more initial labels for the first sensor representation and, based at least on the review, determine whether the initial label(s) is accurate. For instance, the first user may determine whether the initial label(s) accurately represents one or more locations of one or more objects represented by the first sensor representation. If the first user determines that the initial label(s) is accurate, then the first user may provide one or more inputs indicating that the initial label(s) is accurate and/or verified. However, if the first user determines that at least an initial label is inaccurate, then the first user may provide one or more inputs for updating the initial label, such as by updating a location and/or one or more dimensions of the initial label (e.g., of the bounding shape).

Additionally, during the review, the first user may also provide one or more inputs indicating whether one or more objects were wrongfully labeled (e.g., should not be labeled, labeled using the wrong classification, etc.), indicate one or more labels for one or more objects that were not labeled by mistake, and/or perform any other updates to the initial label(s) of the sensor representation. This process may then repeat such that the first user(s) reviews at least a portion of the initial labels for the first sensor representations. For example, the first user(s) may review 2% of the labeled first sensor representations, 5% of the labeled first sensor representations, 10% of the labeled first sensor representations, and/or any other percentage of the labeled first sensor representations. Additionally, based at least on the reviews by the first user(s), the system(s) may generate, obtain, and/or receive new labels (referred to, in some examples, as “first labels” and/or “first human labels”) for the first sensor representations.

As described in more detail herein, the system(s) may also make copies of the first sensor representations (referred to, in some examples, as “second sensor representations) that were reviewed by the first user(s), where the second sensor representations are not initially labeled. The system(s) may then provide the second sensor representations to one or more second client devices for labeling by one or more second users (e.g., one or more second label(s)). In some examples, the second user(s) is different than the first user(s) while, in other examples, at least a portion of the second user(s) is the same as at least a portion of the first user(s). To label a second sensor representation, a second client device may display the second sensor representation to a second user. The second user may then provide one or more inputs indicating one or more labels for one or more objects represented by the second sensor representation. For instance, the input(s) may indicate at least one or more bounding shapes for the object(s), one or more classifications associated with the object(s), and/or any other type of label. This process may then repeat such that the second user(s) provides labels for at least a portion of the second sensor representations. Additionally, based at least on the inputs by the second user(s), the system(s) may generate, obtain, and/or receive labels (referred to, in some examples, as “second labels” and/or “second human labels”) for the second sensor representations.

The system(s) may then use the second labels to generate labels (referred to, in some examples, as “consensus labels” and/or “reference labels”) associated with the first sensor representations. For instance, and as described herein, the consensus labels may be used to measure one or more accuracies associated with the first labels, one or more accuracies associated with one or more individual first users, and/or one or more accuracies associated with the group of the first user(s). For instance, to generate a consensus label, the system(s) may identify the second labels that are associated with the same object as represented by the same second sensor representation. The system(s) may then merge and/or combine the second labels to generate the consensus label for the object as represented by the first sensor representation that corresponds to the second sensor representation. As described herein, the system(s) may use any technique to merge and/or combine the second labels. For example, the system(s) may merge and/or combine the second labels by taking the average of the second labels, the mode of the second labels, the median of the second labels, the second label that includes the highest intersection over union (IoU) with respect to the other second labels, and/or using any other technique. The system(s) may then perform similar processes to generate additional consensus labels associated with the first labels of the first sensor representations.

The system(s) may then use the consensus labels to determine one or more values of one or more metrics (e.g., one or more scores, one or more key performance indicators (KPIs), etc.) representing one or more performances associated with the first user(s) labeling the first sensor representations. For instance, the metric(s) may measure the accuracy and/or efficiency associated with the first user(s) and/or a group that includes the first user(s). For instance, and for a first user, the system(s) may compare the consensus labels associated with the first sensor representations to the first labels associated with the first sensor representations as labeled by the first user to determine the accuracy of the first labels. For example, based at least on the comparing, the system(s) may determine a first value for a first metric indicating whether one or more objects that should be labeled using one or more first labels were labeled, a second value for a second metric indicating whether one or more objects that should not be labeled are wrongfully labeled using one or more first labels, a third value for a third metric indicating whether one or more objects are correctly labeled using one or more first labels (e.g., labeled at the correct locations(s) within the first sensor representation(s)), and/or any other value associated with any other accuracy metric that may be measured for the first labels. The system(s) may then use the value(s) of the metric(s) for the first user to determine a performance score (e.g., a KPI) associated with the first user.

For example, if the value(s) for the metric(s) indicate that the first user accurately labeled all of the first sensor representations, then the system(s) may determine a highest score associated with the first user. However, if the value(s) for the metric(s) indicates that the first user did not accurately label all of the first sensor representations, then the system(s) may determine a lower score associated with the first user. In some examples, the system(s) determines the score as decreasing in value as the number of errors in the labeling increases. For example, the system(s) may determine the highest score when no errors are detected, a second score that is less than the first score when one error is detected, a third score that is less than the second score when two errors are detected, a fourth score that is less than the third score when three errors are detected, and/or so forth.

As described herein, in some examples, the system(s) may perform similar processes to determine a performance score associated with the group of users that includes the first user(s). For instance, the system(s) may compare the consensus labels associated with the first sensor representations to the first labels associated with the first sensor representations as labeled by the first user(s) included in the group to determine the accuracy of the group. Based at least on the comparing, the system(s) may determine the value(s) for the metric(s) that indicates the accuracies of the first labels. Additionally, the system(s) may then use the value(s) of the metric(s) to determine the score associated with the group. Additional description and/or examples on scoring users and/or groups is described with respect to U.S. Non-Provisional application Ser. No. 18/090,052, filed on Dec. 28, 2022, which is hereby incorporated by reference in its entirety.

In some examples, the system(s) may perform additional processes using the comparisons between the consensus labels and the first labels and/or using the scores. For instance, the system(s) may determine which mistakes a first user is making with regard to the labeling, which mistakes the group is making with regard to the labeling, whether a first user is making mistakes based on not understanding labeling instructions, whether the group is making mistakes based on not understanding the labeling instructions, whether the first user is making mistakes based on the labeling instructions being inaccurate, whether the group is making mistakes based on the labeling instructions being inaccurate, and/or any other evaluation information. The system(s) may then cause one or more processes to occur, using the evaluation information, to improve the performance of the labeling. For example, the system(s) may provide one or more of the first user(s) and/or the group with additional labeling instructions and/or may generate new labeling instructions that better indicate how the first sensor representations should be labeled.

In some examples, the system(s) may further evaluate ground truth data that includes at least a portion of the first sensor representations using the comparisons between the consensus labels and the first labels and/or using the scores. For instance, the system(s) may determine one or more scores associated with the ground truth. As described herein, the score(s) may indicate a KPI associated with the ground truth and/or one or more confidence intervals associated with the ground truth. For a first example, the score(s) may include a first score indicating a percentage of the first labels that are inaccurate and/or a second score indicating a percentage of the first labels that are accurate. For a second examples, the score(s) may include a likely score (e.g., a KPI) associated with a percentage of the first labels that are accurate as well as a confidence that that the actual score lies within an upper percentage and a lower percentage associated with the likely score. For instance, if the KPI include 90%, then the system(s) may determine a 95% confidence that the true value lies between 87% and 93%.

In some examples, the system(s) may use one or more of the scores described herein to determine whether the ground truth satisfies one or more product requirements associated with one or more machine learning models that will be trained using the training data. For instance, the system(s) may use the product requirement(s) to determine an accuracy score requirement that the training data needs to meet to satisfy the product requirement(s). The system(s) may then compare a score indicating an accuracy associated with the training data to the accuracy score requirement to determine whether the training data satisfies the product requirement(s) associated with the machine learning model(s).

For example, if the product requirement(s) indicates that a machine learning model must detect 99% of pedestrians within 10 meters of a vehicle, then the system(s) may determine that the training data needs to include an accuracy rate of at least 99% and/or inaccuracy rate of less than 1% with regard to labeling pedestrians that are within 10 meters of the sensor(s) that generated the training data. The system(s) may then determine that the training data satisfies the product requirement(s) based at least on a score associated with the training data, which is labeled to indicate pedestrians within 10 meters of a vehicle, being equal to or greater than accuracy requirement score. However, the system(s) may determine that the training data does not satisfy the product requirement(s) based at least on the score associated with the training data being less than the accuracy requirement score. Determining whether training data satisfies product requirements for machine learning models is described in more detail herein.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems for implementing visual language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

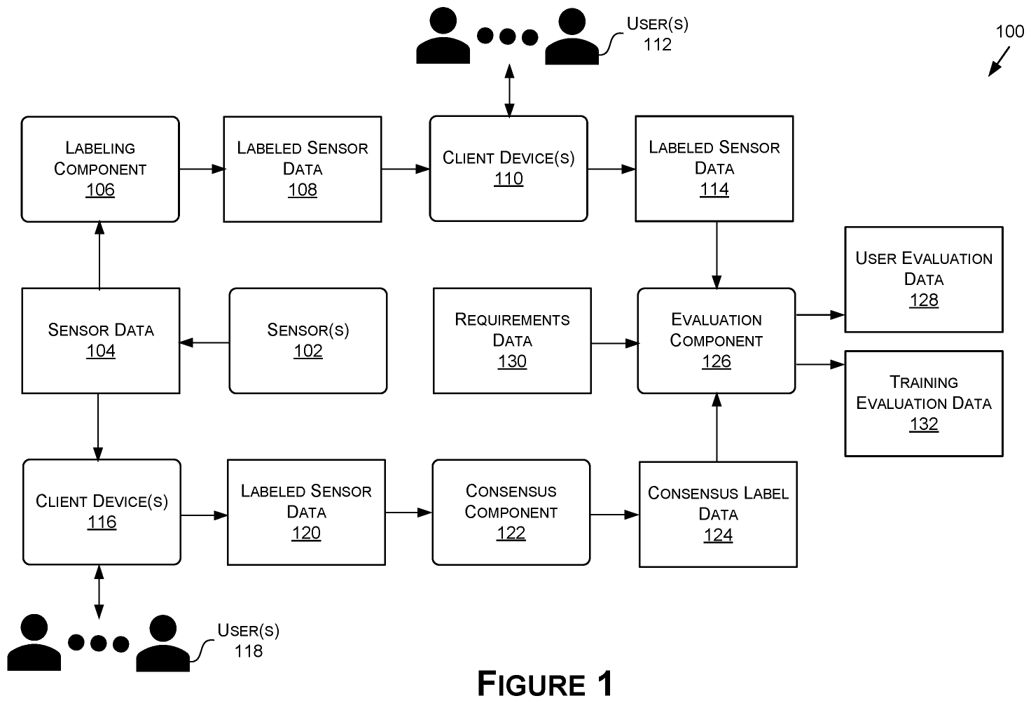

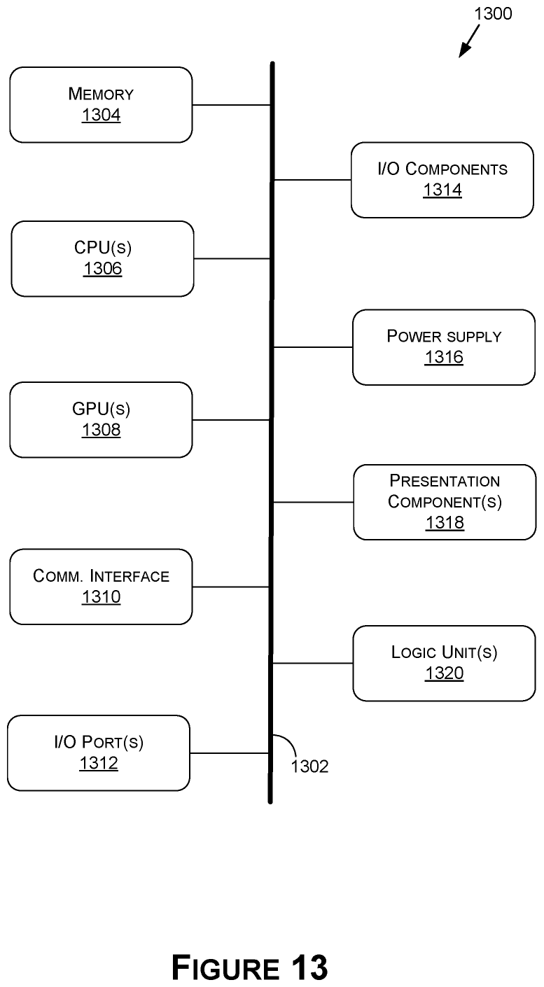

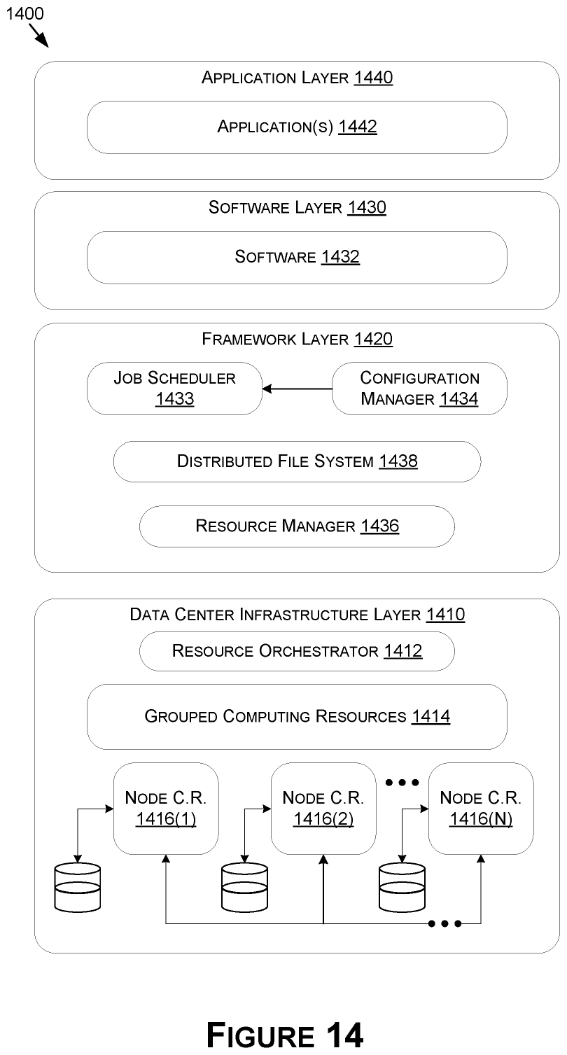

With reference to FIG. 1A, FIG. 1 illustrates an example data flow diagram for a process 100 of evaluating labels associated with training data, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1200 of FIGS. 12A-12D, example computing device 1300 of FIG. 13, and/or example data center 1400 of FIG. 14.

The process 100 may include one or more sensors 102 generating sensor data 104 representing at least an environment. In some examples, the sensor(s) 102 may be associated with one or more machines, such as one or more of the autonomous vehicles 1200, navigating within the environment. As described herein, the sensor data 104 may include, but is not limited to, image data generated using one or more image sensors (e.g., one or more cameras), LiDAR data generated using one or more LiDAR sensors, RADAR data generated using one or more RADAR sensors, and/or any other type of sensor data generated using any other type of sensor. Additionally, the sensor data 104 may represent sensor representations, such as camera images, LiDAR images, LiDAR point clouds, and/or any other type of sensor representations that further represent one or more objects located within the environment. As described herein, an object may include, but is not limited to, a vehicle (e.g., a car, a bus, a van, motorcycle, etc.), a pedestrian, an animal, a traffic feature (e.g., a traffic signal, a traffic sign, a road marking, a curb, etc.), a structure, and/or any other type of object that may be located within the environment.

As described herein, in some examples, the sensor data 104 may represent duplicates associated with the sensor representations. For instance, if the process 100 is associated with a number of users labeling the sensor representations, then the sensor data 104 may represent a number of copies associated with the sensor representations that is similar to the number of labels. For example, if ten users are going to label the sensor representations, and for a sensor representation, the sensor data 104 may represent ten copies of the sensor representation. This way, and as described further herein, one or more users (e.g., each user) is able to label a respective copy of the sensor representation.

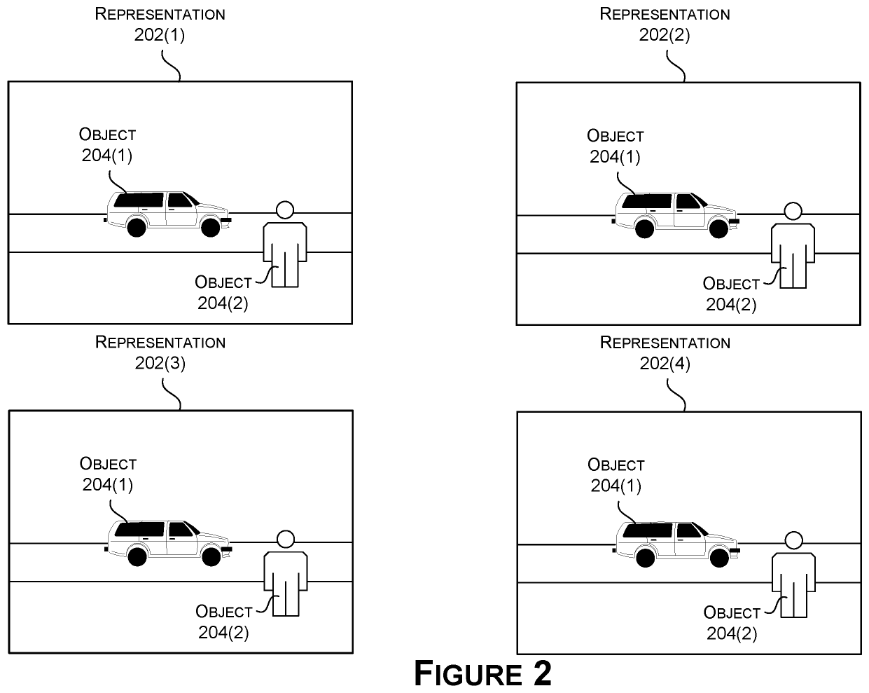

For instance, FIG. 2 illustrates an example of copies of a sensor representation that may be labeled using a number of users, in accordance with some embodiments of the present disclosure. As shown, a machine navigating with an environment may use one or more sensors (e.g., the sensor(s) 102) to generate a first sensor representation 202(1) that represents at least a first object 204(1) (e.g., a vehicle) and a second object 204(2) (e.g., a pedestrian). While the example of FIG. 2 illustrates the first sensor representation 202(1) as including an image, such as a camera image, in other examples, the first sensor representation 202(1) may include any other type of representation associated with sensor data. As further shown, the first sensor representation 202(1) may then be copied to generate at least a second sensor representation 202(2), a third sensor representation 202(3), and a fourth sensor representation 202(4). While the example of FIG. 2 illustrates four copies of the same sensor representation 202(1)-(4) (also referred to singularly as “sensor representation 202” or in plural as “sensor representations 202”), in other examples, any number copies of the sensor representation 202 may be generated.

Referring back to the example of FIG. 1, the process 100 may include a labeling component 106 processing the sensor data 104 and, based at least on the processing, generating labeled sensor data 108 representing the sensor representations labeled using initial labels. For instance, the labeling component 106 may process the sensor data 104 using one or more machine learning models, one or more neural networks, one or more algorithms, one or more modules, and/or any other type of component that is configured to perform object detection, object tracking, object recognition, and/or any other sensor processing techniques. As described herein, a label for a sensor representation may indicate a location of an object as represented by the sensor representation. For example, the label may include a two-dimensional (2D) bounding shape and/or a three-dimensional (3D) bounding shape, such as a bounding box, a bounding cuboid, a bounding pentagon, a bounding hexagon, a bounding heptagon, and/or any other shape. In some examples, a bounding shape may be represented using any technique, such as one or more locations (e.g., the x-coordinate location(s), the y-coordinate location(s), and/or the z-coordinate location(s)) of one or more points (e.g., the pixel(s), etc.) that represent at least a portion (e.g., the outer barrier) of the bounding shape, and/or any other technique.

In some examples, a label for the sensor representation may include additional information associated with the object, such as a classification (e.g., vehicle, pedestrian, animal, structure, etc.) associated with the object, a sub-classification (e.g., car, van, bus, motorcycle and/or the like for vehicles) associated with the object, and/or a confidence associated with the bounding shape, the classification, and/or the sub-classification. In some examples, the type of labels generated using the labeling component 106 may depend on one or more factors, such as the type of training data that is being generated and/or one or more product requirements associated with a machine learning model being trained using the training data. For a first example, if the training data is associated with training a machine learning model to detect vehicles, then the labeling component 106 may be configured to label the vehicles represented by the sensor representations. For a second example, if the training data is associated with training a machine learning model to detect pedestrians that are within a specific distance to vehicles, then the labeling component 106 may be configured to label the pedestrians that are within the specific distance to the sensor(s) 102 that generated the sensor representations.

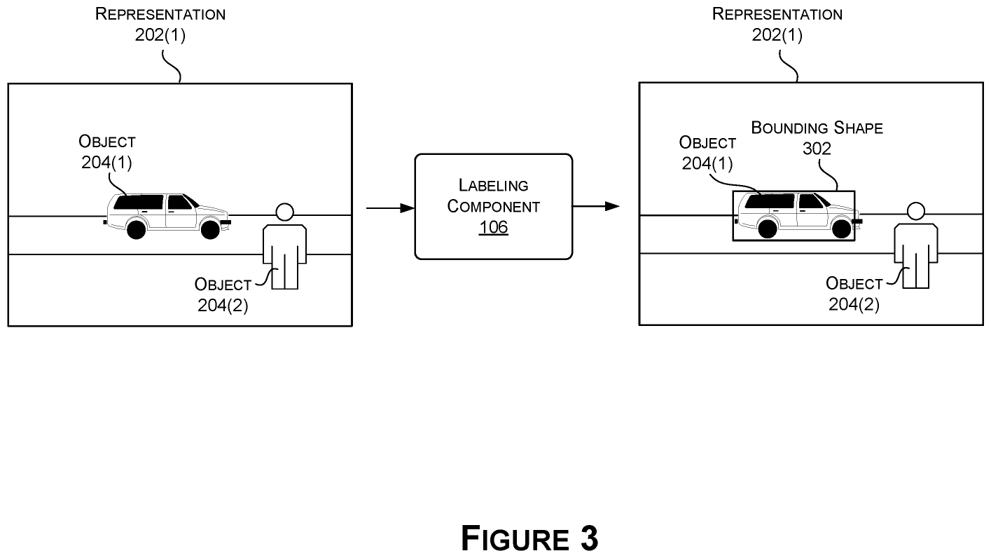

For instance, FIG. 3 illustrates an example of processing sensor data to determine initial labels for objects represented by a sensor representation, in accordance with some embodiments of the present disclosure. As shown, the labeling component 106 may process the sensor data representing the first sensor representation 202(1) and, based at least on the processing, determine a bounding shape 302 associated with the first object 204(1). However, and as shown, the bounding shape 302 may not correctly indicate the location of the first object 204(1) since the bounding shape 302 does not enclose an entirety of the first object 204(1). Additionally, in the example of FIG. 3, the labeling component 106 may not generate a label for the second object 204(2) even though the second object 204(2) should have been labeled. For instance, ground truth data that includes at least the first sensor representation 202(1) may be associated with product requirements indicating that both vehicles and pedestrians should be labeled. While the example of FIG. 3 illustrates the first sensor representation 202(1) is being labeled incorrectly by the labeling component 106, this is just for illustrated reasons and, in other examples, the labeling component 106 may accurately label some and/or all sensor representations.

Referring back to the example of FIG. 1, the process 100 may include one or more first client devises 110 receiving at least a portion of the labeled sensor data 108 and displaying sensor representations, as labeled, represented by the at least the portion of the labeled sensor data 108 to one or more first users 112. As described herein, at least the portion of the labeled sensor data 108 may include, but is not limited to, labeled sensor data 108 representing 2% of the sensor representations, 5% of the sensor representations, 10% of the sensors representations, and/or any other percentage of the sensor representations.

The process 100 may then include the first user(s) 112 using the first client device(s) 110 to review the initial labels associated with the sensor representations. For instance, and for a sensor representation, a first client device 110 may display the sensor representation to a first user 112. The first user may then review one or more initial labels for the sensor representation and, based at least on the review, determine whether the initial label(s) is accurate. For instance, the first user 112 may determine whether the initial label(s) accurately represents one or more locations of one or more objects represented by the sensor representation and/or one or more classification associated with the object(s). If the first user 112 determines that the initial label(s) is accurate, then the first user 112 may provide one or more inputs indicating that the initial label(s) is accurate and/or verified. However, if the first user 112 determines that at least an initial label is inaccurate, then the first user 112 may provide one or more inputs for updating the initial label, such as by updating a location and/or one or more dimensions of the initial label.

Additionally, during the review, the first user 112 may also provide one or more inputs indicating whether one or more objects were wrongfully labeled (e.g., should not be labeled, labeled using the wrong classification, etc.), indicating one or more labels for one or more objects that should have been labeled, and/or perform any other updates to the initial label(s) of the sensor representation. This process may then repeat such that the first user(s) 112 reviews any number of copies of the sensor representation, such as one copy, three copies, five copies, ten copies, and/or the like. Additionally, this process may continue to repeat such that the first user(s) 112 reviews the initial labels for additional sensor representations. Furthermore, based on the reviews by the first user(s) 112, the system(s) may generate, obtain, and/or receive new labels (referred to, in some examples, as “first labels”) for the sensor representations, where the sensor representations labeled with the first labels may be represented by labeled sensor data 114.

As described herein, in some examples, multiple users (e.g., two users, five users, ten users, etc.) may perform these processes to review one or more initial labels for a single sensor representation. For instance, if the process 100 includes five users 112 reviewing the initial labels for the sensor representations, then five client devices 110 may present the same sensor representation with the same initial label(s) for review by the five users 112. Additionally, in some examples and as described herein, the first user(s) 112 may only review the initial labels for only a portion of the senor representations, such as 2%, 5%, 10%, and/or any other percentage of the sensor representations. As such, for sensor representations not reviewed by the first user(s) 112, the initial labels may include the first labels represented by the labeled sensor data 114.

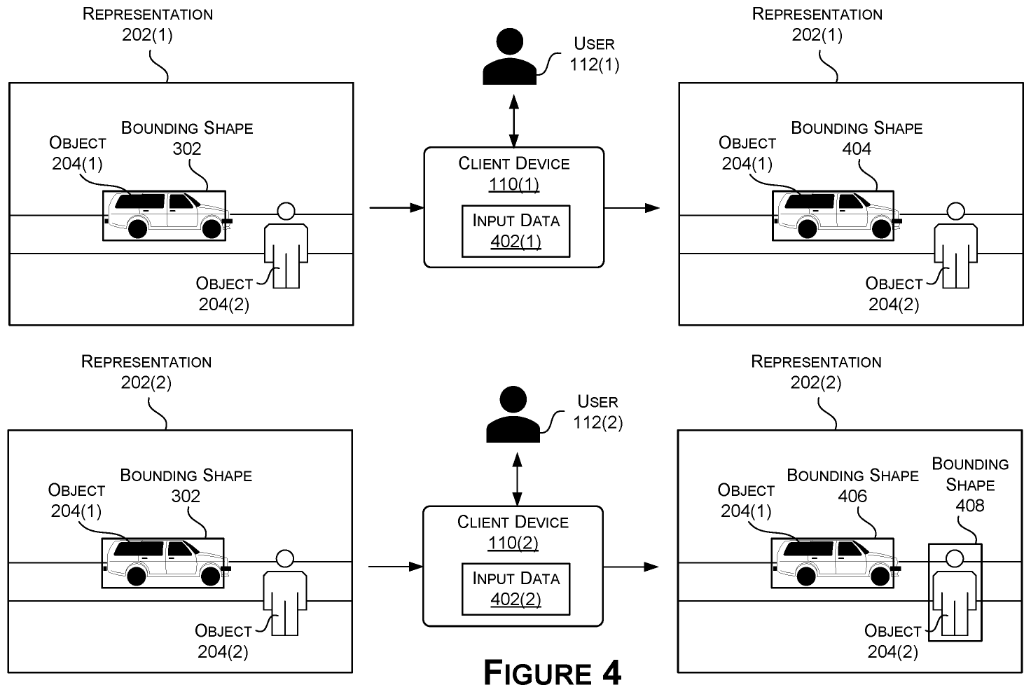

For instance, FIG. 4 illustrates an example of users reviewing initial labels for a sensor representation, in accordance with some embodiments of the present disclosure. As shown, a client device 110(1) may present, to a user 112(1), the first sensor representation 202(1) that is labeled with the bounding shape 302 for the first object 204(1). While presenting the first sensor representation 202(1), the client device 110(1) may receive one or more inputs represented by input data 402(1), where the input(s) is associated with verifying the initial labels that are accurate and/or updating the initial labels that are inaccurate. For instance, in the example of FIG. 4, the user 112(1) associated with the client device 110(1) may indicate that the initial labels for the first sensor representation 202(1) are accurate. As such, the client device 110(1) may not update the initial labels for the first sensor representation 202(1) such that the labels include a bounding shape for the first object 204(1) that matches the bounding shape 302 for the first object 204(1).

As further shown, a client device 110(2) may present the second sensor representation 202(2) to another user 112(2), where the second sensor representation 202(2) is also labeled with the bounding shape 302 for the first object 204(1) since the second sensor representation 202(2) includes a copy of the first sensor representation 202(1). While presenting the second sensor representation 202(2), the client device 110(2) may receive one or more inputs represented by input data 402(2), where the input(s) is associated with verifying the initial labels that are accurate and/or updating the initial labels that are inaccurate. For instance, in the example of FIG. 4, the user 112(2) associated with the client device 110(2) may indicate that the bounding shape 302 for the first object 204(1) is accurate, which is indicated by a bounding shape 406 for the first object 204(1). The user 112(2) associated with the client device 110(2) may also indicate a new label for the second object 204(2) that includes a bounding shape 408.

As described herein, in some examples, the users 112(1)-(2) may both indicate that the bounding shape 302 is accurate since the users may rely too much on the initial labels from the labeling component 106. Additionally, while the example of FIG. 4 illustrates the two users 112(1)-(2) using the two client devices 110(1)-(2) to review the two copies of the sensor representation 202, in other examples, any number of users 112 may use any number of client devices 110 to review any number of copies of the sensor representation 202. Additionally, in some examples, similar processes may be used to review labels for any number of other sensor representations.

Referring back to the example of FIG. 1, the process 100 may include one or more second client devise 116 receiving at least a portion of the sensor data 104 and presenting sensor representations represented by the at least the portion of the sensor data 104 to one or more second users 118. As described herein, the sensor representations presented using the second client device(s) 116 may include copies of the sensor representations presented using the first client device(s) 110, but without the initial labels.

The process 100 may then include the second user(s) 118 using the second client device(s) 116 to label the sensor representations with labels. For instance, to label a sensor representation, a second client device 116 may present the sensor representation to a second user 118. The second user 118 may then provide one or more inputs indicating one or more labels for one or more objects represented by the sensor representation. For instance, the input(s) may indicate at least one or more bounding shapes for the object(s), one or more classifications associated with the object(s), and/or any other type of label. This process may then repeat such that the second user(s) 118 reviews any number of copies of the sensor representation, such as one copy, three copies, five copies, ten copies, and/or the like. Additionally, this process may continue to repeat such that the second user(s) 118 labels additional sensor representations. Furthermore, based on the labeling by the second user(s) 118, the system(s) may generate, obtain, and/or receive labels (referred to, in some examples, as “second labels”) for the sensor representations, where the sensor representations labeled with the second labels may be represented by labeled sensor data 120.

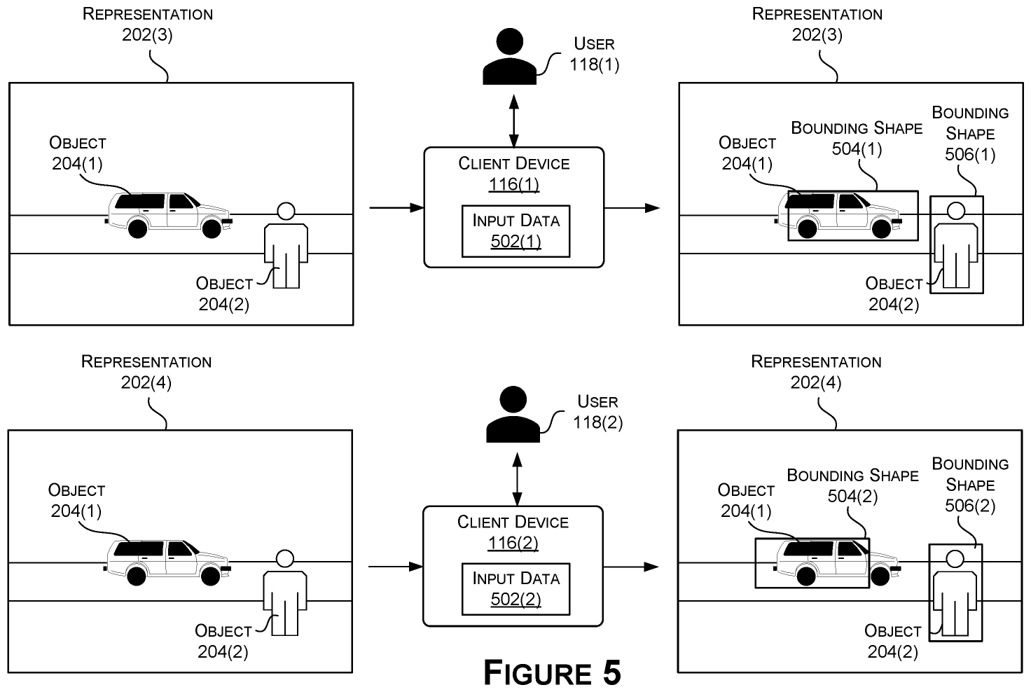

For instance, FIG. 5 illustrates an example of users labeling a sensor representation, in accordance with some embodiments of the present disclosure. As shown, a client device 116(1) may present the third sensor representation 202(3) a user 118(2), where the third sensor representation 202(3) does not include any initial labels in contrast the sensor representations 202(1)-(2) in the example of FIG. 4. While presenting the third sensor representation 202(3), the client device 116(1) may receive one or more inputs represented by input data 502(1), where the input(s) is associated with generating the labels for the third sensor representation 202(3). For example, the input(s) may indicate at least a first bounding shape 504(1) for the first object 204(1) and a first bounding shape 506(1) for the second object 204(2).

Additionally, a client device 116(2) may present the fourth sensor representation 202(4) a user 118(2), where the fourth sensor representation 202(4) also does not include any initial labels in contrast to the sensor representations 202(1)-(2) in the example of FIG. 4. While presenting the fourth sensor representation 202(4), the client device 116(2) may receive one or more inputs represented by input data 502(2), where the input(s) is associated with generating the labels for the fourth sensor representation 202(4). For example, the input(s) may indicate at least a second bounding shape 504(2) for the first object 204(1) and a second bounding shape 506(2) for the second object 204(2).

While the example of FIG. 5 illustrates the two users 118(1)-(2) using the two client devices 116(1)-(2) to label the two copies of the sensor representation 202, in other examples, any number of users 118 may use any number of client devices 116 to generate labels for any number of copies of the sensor representations 202. Additionally, in some examples, similar processes may be used to generate labels for any number of other sensor representations.

Referring back to the example of FIG. 1, the process 100 may include a consensus component 122 using at least the labeled sensor data 120 to generate consensus labels (also referred to as “reference labels”) associated with the sensor representations. For instance, and as described herein, the consensus labels may be used to measure one or more accuracies associated with the first labels, one or more accuracies associated with one or more individual first users 112, and/or one or more accuracies associated with the group of first user(s) 112. For instance, to generate a consensus label, the consensus component 122 may identify the second labels that are associated with the same object as represented by the copies of the same sensor representation. The consensus component 122 may then merge and/or combine the second labels to generate the consensus label for the object as represented by the sensor representation. As described herein, the consensus component 122 may use any technique to merge and/or combine the second labels. For example, the consensus component 122 may merge and/or combine the second labels by taking the average of the second labels, the mode of the second labels, the median of the second labels, the second label that includes the highest intersection over union (IoU) with respect to the other second labels, and/or using any other technique.

The consensus component 122 may then perform similar processes to generate additional consensus labels associated with any number of objects represented by any number of sensor representations. Additionally, the consensus component 122 may generate and/or output consensus label data 124 representing the consensus labels associated with the sensor representations.

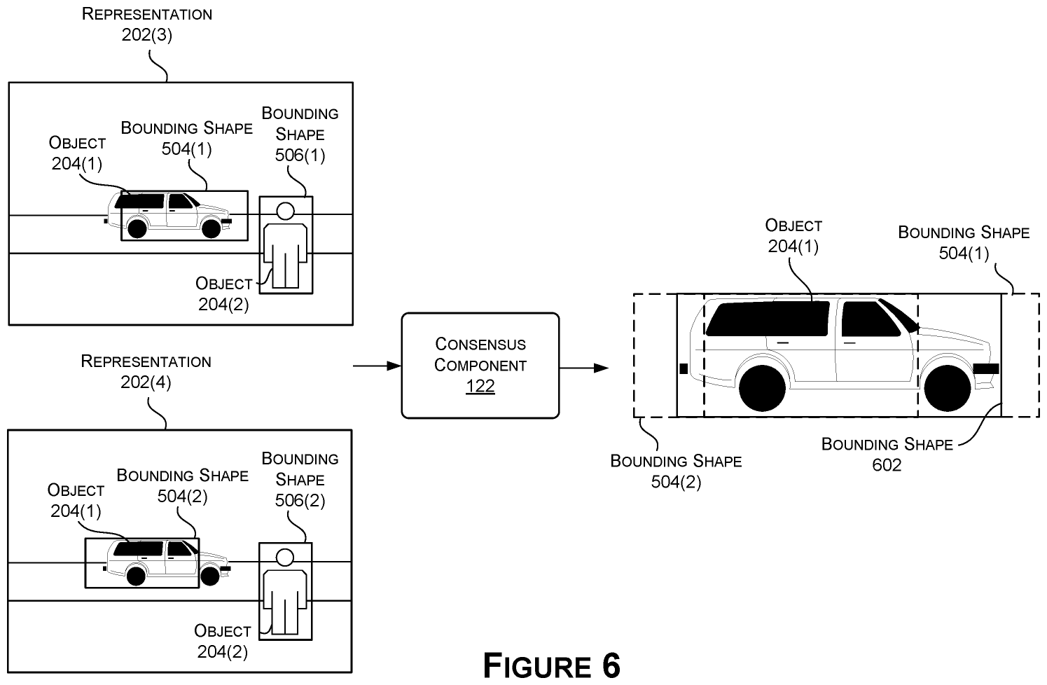

For instance, FIG. 6 illustrates an example of generating a consensus label associated with an object represented by a sensor representation, in accordance with some embodiments of the present disclosure. As shown, the consensus component 122 may use at least the first bounding shape 504(1) associated with the first object 204(1) and the second bounding shape 504(2) associated with the first object 204(1) to generate a consensus bounding shape 602 associated with the first object 204(1). In the example of FIG. 6, the consensus component 122 may generate the consensus bounding shape 602 as including the average of the bounding shapes 504(1)-(2) and/or using the IoU associated with the bounding shapes 504(1)-(2). However, in other examples, the consensus component 122 may use any other technique to generate the consensus bounding shape 602 using the bounding shapes 504(1)-(2). Additionally, in some examples, the consensus component 122 may perform similar processes for any number of objects represented by any number of sensor representations.

Referring back to the example of FIG. 1, the process 100 may include an evaluation component 126 using the consensus labels to determine one or more values of one or more metrics (e.g., one or more scores, one or more KPIs, etc.) representing one or more performances associated with the first user(s) 112 labeling the sensor representations. For instance, the metric(s) may measure the accuracy and/or efficiency associated with the first user(s) 112 and/or a group of users that includes the first user(s) 112. For instance, and for a first user 112, the evaluation component 126 may compare the consensus labels associated with the sensor representations to the first labels associated with the sensor representations as labeled by the first user 112 to determine the accuracies of the first labels. Based at least on the comparing, the evaluation component 126 may determine a first value for a first metric indicating whether one or more objects that should be labeled using one or more first labels are labeled, a second value for a second metric indicating whether one or more objects that should not be labeled are labeled using one or more first labels, a third value for a third metric indicating whether one or more objects are correctly labeled using one or more first labels (e.g., labeled at the correct locations(s) within the sensor representation(s)), and/or any other value associated with any other accuracy metric that may be measured for the first labels. The evaluation component 126 may then use the value(s) of the metric(s) for the first user 112 to determine a performance score (e.g., a KPI) associated with the first user 112.

For example, if the value(s) for the metric(s) indicates that the first user 112 accurately labeled all of the sensor representations, then the evaluation component 126 may determine a highest score associated with the first user 112. However, if the value(s) for the metric(s) indicates that the first user 112 did not accurately label all of the sensor representations, then the evaluation component 126 may determine a lower score associated with the first user 112. In some examples, the evaluation component 126 determines the score as decreasing in value as the number of errors in the labeling increases. For example, the evaluation component 126 may determine the highest score when no errors are detected, a second score that is less than the first score when one error is detected, a third score that is less than the second score when two errors are detected, a fourth score that is less than the third score when three errors are detected, and/or so forth. The evaluation component 126 may then generate and/or output user evaluation data 128 representing the value(s) of the metric(s) and/or the score associated with the first user 112.

As described herein, in some examples, the evaluation component 126 may perform similar processes to determine a performance score associated with the group of users that includes the first user(s) 112. For instance, the evaluation component 126 may compare the consensus labels associated with the sensor representations to the first labels associated with the sensor representations as labeled by the first user(s) 112 included in the group to determine the accuracy of the group. Based at least on the comparing, the system(s) may determine the value(s) for the metric(s) that indicate the accuracies of the first labels. For example, the evaluation component 126 may determine a first value for a first metric indicating whether objects that should be labeled using first labels are labeled, a second value for a second metric indicating whether objects that should not be labeled are labeled using first labels, a third value for a third metric indicating whether objects are correctly labeled using first labels (e.g., labeled at the correct locations within the sensor representations), and/or any other value associated with any other accuracy metric that may be measured for the first labels The consensus component 122 may then use the value(s) of the metric(s) to determine the score associated with the group.

For example, if the value(s) for the metric(s) indicates that the group accurately labeled all of the sensor representations, then the evaluation component 126 may determine a highest score associated with the group. However, if the value(s) for the metric(s) indicates that the group did not accurately all of the sensor representations, then the evaluation component 126 may determine a lower score associated with the group. In some examples, the evaluation component 126 determines the score as decreasing in value as the number of errors in the labeling increases. For example, the evaluation component 126 may determine the highest score when no errors are detected, a second score that is less than the first score when one error is detected, a third score that is less than the second score when two errors are detected, a fourth score that is less than the third score when three errors are detected, and/or so forth. The evaluation component 126 may then generate and/or output user evaluation data 128 representing the value(s) of the metric(s) and/or the score associated with the group.

In some examples, the evaluation component 126 may perform additional processes using the comparisons between the consensus labels and the first labels and/or using the scores. For instance, the evaluation component 126 may determine which mistakes a first user 112 is making with regard to the labeling and/or which mistakes the group is making with regard to the labeling. For example, the evaluation component 126 may determine that the first user 112 and/or the group continues to mislabel the locations of vehicles within the sensor representations. Additionally, the evaluation component 126 may determine whether a first user 112 is making mistakes based on not understanding labeling instructions and/or whether the group is making mistakes based on not understanding the labeling instructions. For example, the evaluation component 126 may determine that the first user 112 and/or the group is not labeling a specific type of object, such as motorcycles, based on not understanding that the instructions indicate to label the specific type of object.

Furthermore, the evaluation component 126 may determine whether the first user 112 is making mistakes based on the labeling instructions being inaccurate and/or whether the group is making mistakes based on the labeling instructions being inaccurate. For example, the evaluation component 126 may determine that the first user 112 and/or the group is not labeling a specific type of object, such as animals, based on the instructions not instructing the first user 112 and/or the group to label the specific type of object even though the specific type of object should be labeled (e.g., based on product requirements associated with training data). The evaluation component 126 may then cause one or more processes to occur, using the evaluation information, to improve the performance of the labeling. For example, the evaluation component 126 may provide one or more of the first user(s) 112 and/or the group with additional labeling instructions and/or may generate new labeling instructions that better indicate how the sensor representations should be labeled.

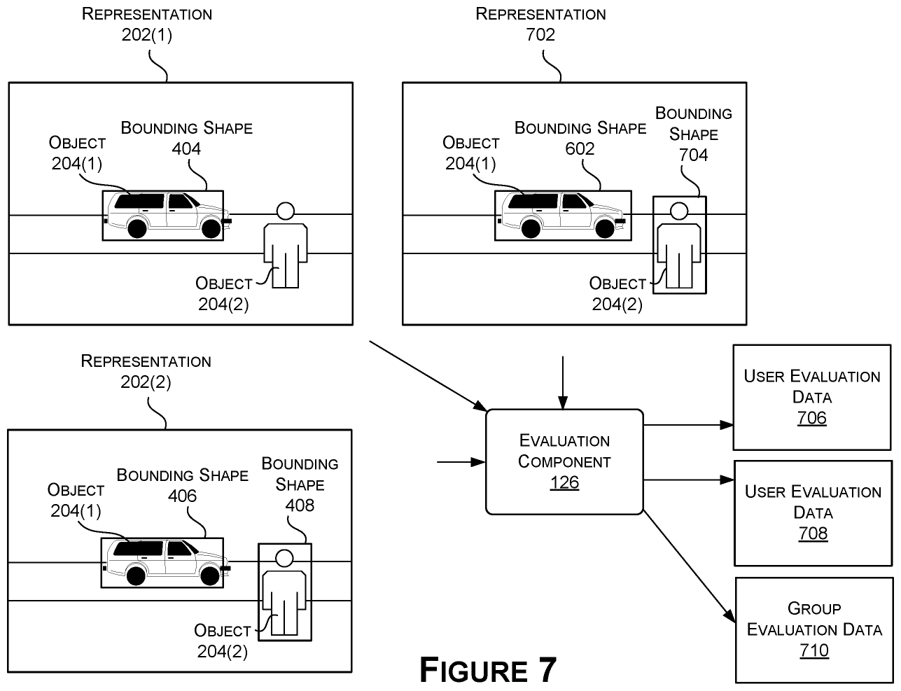

For instance, FIG. 7 illustrates an example of using consensus labels to evaluate labels associated with a sensor representation, in accordance with some embodiments of the present disclosure. As shown, the evaluation component 126 may compare consensus labels associated with a consensus sensor representation 702 to the labels associated with the first sensor representation 202(1) to determine one or more values associated with one or more metrics. For instance, based at least on the comparing, the evaluation component 126 may determine whether the bounding shape 404 is correct using the consensus bounding shape 602 for the first object 204(1). In some examples, the evaluation component 126 may determine that the bounding shape 404 is correct based at least on the bounding shape 404 including at least some overlap with the consensus bounding shape 602 (e.g., using the IoU). In some examples, the evaluation component 126 may determine that the bounding shape 404 is correct based at least on the bounding shape 404 including at least a threshold amount overlap with the consensus bounding shape 602 (e.g., using the IoU). The threshold amount of overlap may include, but is not limited to, 50%, 75%, 90%, 95%, 99%, and/or any other percentage.

However, based on the comparing, the evaluation component 126 may also determine that the second object 204(2) is not labeled correctly using a consensus bounding shape 704 for the second object 204(2) since the second object 204(2) does not include a label associated with the first sensor representation 202(1). The evaluation component 126 may then determine a first score associated with the user 112(1) based at least on the value(s) of the metric(s) associated with the evaluation, where the first score may be represented by user evaluation data 706.

Additionally, based at least on the comparing, the evaluation component 126 may determine whether the bounding shape 406 is correct using the consensus bounding shape 602 for the first object 204(1), using similar processes as the bounding shape 404. Furthermore, based at least on the comparing, the evaluation component 126 may determine whether the bounding shape 408 is correct using the consensus bounding shape 704, using similar processes as the bounding shape 404. The evaluation component 126 may then determine a second score associated with the user 112(2) based at least on the value(s) of the metric(s) associated with the evaluation, where the second score may be represented by user evaluation data 708. In the example of FIG. 7, the second score may be greater than the first score based at least on the user 112(2) better labeling the objects 204(1)-(2) as compared to the user 112(1).

In some examples, the evaluation component 126 may also perform similar processes to determine a score associated with the group of the users 112(1)-(2), where the score may be represented by group evaluation data 710. In some examples, the evaluation component 126 may also determine additional information associated with the labeling performed by the individual users 112(1)-(2) and/or the group. For a first example, based at least on the user 112(1) not labeling the second object 204(2), the evaluation component 126 may determine that the user 112(1) is making the mistake of not labeling a type (e.g., pedestrians) associated with the second object 204(2), whether the user 112(1) is making the mistake based on not understanding the instructions, and/or whether the user 112(1) is making the mistake based on the instructions being inaccurate. For a second example, based at least on the users 112(1)-(2) not labeling an entirety of the first object 204(1) with the bounding shapes 404 and 406, the evaluation component 126 may determine that the group is making the mistake of not correctly labeling a type (e.g., a vehicle) associated with the first object 204(1), whether the group is making the mistake based on not understanding the instructions (e.g., include an entirety of the vehicle within the bounding shape), and/or whether the group is making the mistake based on the instructions being inaccurate.

Referring back to the example of FIG. 1, in some examples, the evaluation component 126 may further evaluate ground truth data that includes at least a portion of the sensor representations using the comparisons between the consensus labels and the first labels and/or using the scores. For instance, the evaluation component 126 may determine one or more scores associated with the ground truth. As described herein, the score(s) may indicate a KPI associated with the ground truth and/or one or more confidence intervals associated with the ground truth. For a first example, the score(s) may indicate a first score indicating a percentage of the first labels that are inaccurate and/or a second score indicating a percentage of the first labels that are accurate. For a second examples, the score(s) may include a likely score (e.g., a KPI) associated with a percentage of the first labels that are accurate as well as a confidence that that the actual score lies within an upper percentage and a lower percentage associated with the likely score. For instance, if the KPI include 90%, then the evaluation component 126 may determine a 95% confidence that the true value lies between 87% and 93%.

In some examples, the evaluation component 126 may use one or more of the scores described herein to determine whether the ground truth satisfies one or more product requirements associated with one or more machine learning models that will be trained using the training data, where the product requirement(s) may be represented by requirement data 130. For instance, the evaluation component 126 may use the product requirement(s) to determine a target score that the training data needs to meet to satisfy the product requirement(s). For a first example, if the product requirement(s) indicates that a machine learning model must detect 99% of pedestrians within 10 meters of a vehicle, then the evaluation component 126 may determine that the training data needs to be 99% accurate with regard to labeling pedestrians that are within 10 meters of the sensor(s) that generated the training data, which may give a target score of 99% accurate and/or a target score of 1% inaccurate.

For a second example, if the product requirement(s) indicates that a machine learning model must detect 90% of vehicles that are between 10 meters and 20 meters from a vehicle, then the evaluation component 126 may determine that the training data needs to be 90% accurate with regard to vehicles that are between 10 meters and 20 meters from the sensor(s) that generated the training data, which may give a target score of 90% accurate and/or a target score of 10% inaccurate. While these are just a few example techniques of the evaluation component 126 using the product requirement(s) to determine a target score associated with training data, in other examples, the evaluation component 126 may use any other technique to determine the target score using the product requirement(s).

The evaluation component 126 may then determine whether the product requirement(s) is satisfied based at least on the score associated with the training data and the target score associated with the product requirement(s). For a first example, and using the first example above, the evaluation component 126 may determine that the training data satisfies the product requirement(s) based at least on an accuracy score associated with the training data satisfying (e.g., being equal to or greater than) the target accuracy score of 99% associated with the product requirement(s). Alternatively, the evaluation component 126 may determine that the training data does not satisfy the product requirement(s) based at least on the accuracy score associated with the training data not satisfying (e.g., being less than) the target accuracy score of 99% associated with the product requirement(s). For a second example, and again using the first example above, the evaluation component 126 may determine that the training data satisfies the product requirement(s) based at least on an inaccuracy score associated with the training data satisfying (e.g., being less than or equal to) the target inaccuracy score of 1% associated with the product requirement(s). Alternatively, the evaluation component 126 may determine that the training data does not satisfy the product requirement(s) based at least on the inaccuracy score associated with the training data not satisfying (e.g., being greater than) the target inaccuracy score of 1% associated with the product requirement(s).

In some examples, the evaluation component 126 may then generate and/or output training evaluation data 132 indicating whether the product requirement(s) for the training data is satisfied, the target score(s) associated with the product requirement(s), and/or the determined score(s) associated with the training data. In some examples, the evaluation component 126 may then cause one or more further processes to occur, such as the training data to go through additional review when the training data does not satisfy the product requirement(s).

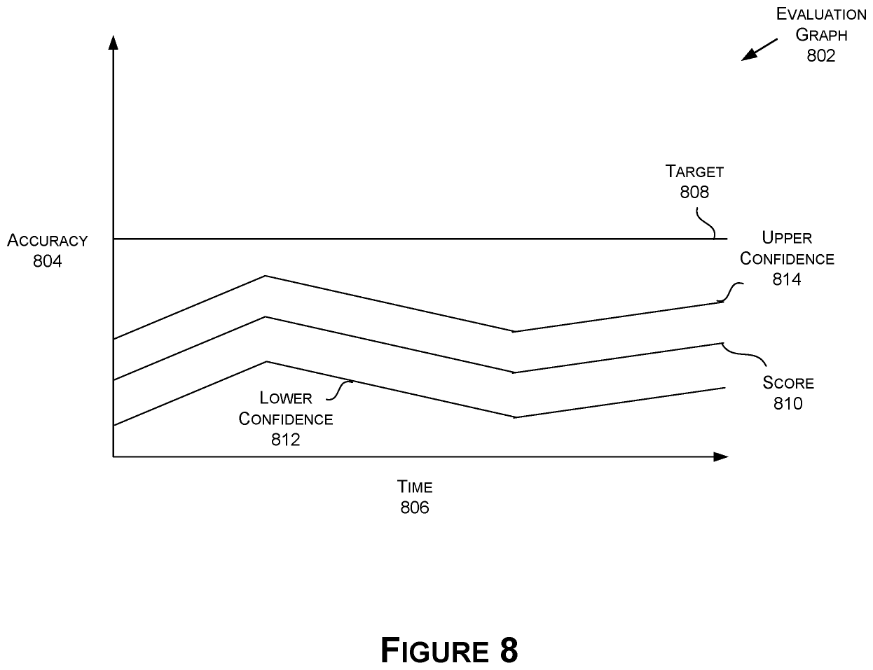

For instance, FIG. 8 illustrates an example of determining whether training data satisfies one or more product requirements, in accordance with some embodiments of the present disclosure. As shown, an evaluation graph 802 may indicate an accuracy 804 associated with the training data over a time 806 that the training data is being generated. In the example of FIG. 8, the accuracy 804 may indicate a percentage of the labels that are inaccurate with respect to the training data. However, in other examples, the accuracy 804 may indicate a percentage of the labels that are accurate with respect to the training data.

The evaluation graph 802 further indicates a target score 808 associated with the training data. For instance, and using the example above, if the product requirement(s) indicates that a machine learning model must detect 99% of pedestrians within 10 meters of a vehicle, then the evaluation component 126 may determine that the training data needs to be 99% accurate with regard to labeling pedestrians that are within 10 meters of the sensor(s) that generated the training data, which may give the target score 808 of 1% for inaccuracies. The evaluation graph 802 further indicates a score 810 associated with the training data. As shown, the score 810 may change over time 806 based on the training data receiving additional labeled sensor representations.

The evaluation graph 802 may further indicate a confidence associated with the score 810, where the confidence is indicated by a lower confidence 812 and an upper confidence 814. For example, the lower confidence 812 and the upper confidence 814 may indicate a 95% confidence (and/or any other percentage of confidence) that the score 810 is accurate, such as indicates the correct error associated with the training data.

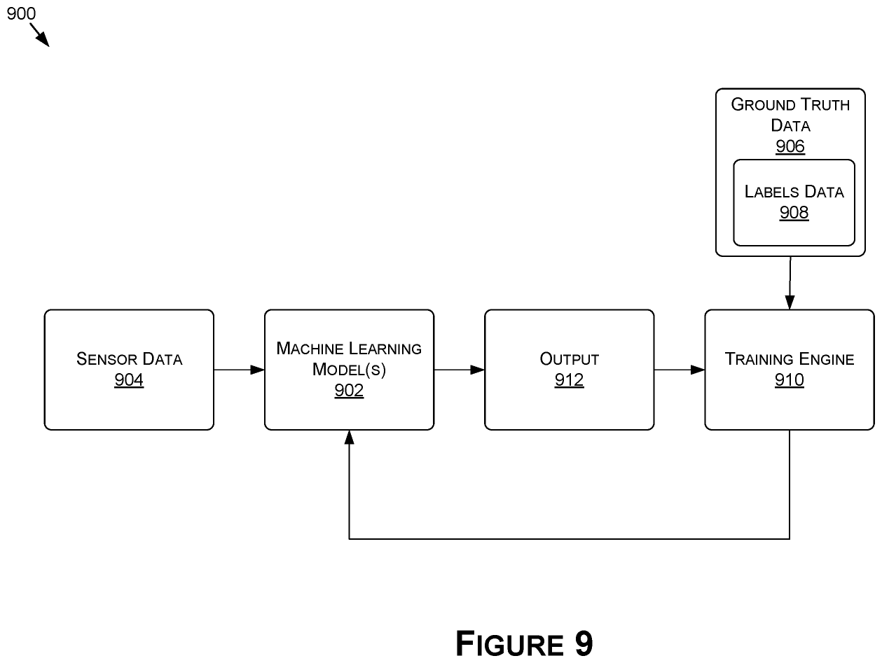

As described herein, in some examples, the labeled sensor data 104 may be used to train one or more models to perform one or more tasks. As such, in such examples, the labels from the labeled sensor data 114 and/or the labels from the labeled sensor data 120 may correspond to ground truth data (e.g., ground truth labels) for the sensor data 104 that is used to train the model(s). For instance, FIG. 9 illustrates a data flow diagram illustrating a process 900 for training one or more machine learning models 902 to perform one or more tasks, in accordance with some embodiments of the present disclosure. As described herein, the task(s) may include, but is not limited to, object recognition, object tracking, trajectory planning, machine localization, and/or any other task for which the machine learning model(s) 902 may be trained.

As shown, the machine learning model(s) 902 may be trained using sensor data 904 (which may represent, and/or include, the sensor data 104). When including image data, the sensor data 904 used for training may include original images (e.g., as captured by one or more image sensors), down-sampled images, up-sampled images, cropped or region of interest (ROI) images, otherwise augmented images, and/or a combination thereof. The sensor data 904 may be images captured by one or more sensors (e.g., the sensor(s) 102) of various machines, and/or may be images captured from within a virtual environment used for testing and/or generating training images (e.g., a virtual camera of a virtual machine within a virtual or simulated environment). In some examples, the sensor data 904 may include images from a data store or repository of training images (e.g., images of driving surfaces). Still, in some examples, the sensor data 904 may include other types of data.

The machine learning model(s) 902 may be trained using the sensor data 904 as well as corresponding ground truth data 906. The ground truth data 906 may include annotations, labels, masks, and/or the like. For example, in some examples, the ground truth data 906 may include labels data 908. As described herein, in some examples, the labels data 908 may represent, and/or include, the labels from the labeled sensor data 114 and/or the labeled sensor data 120. The ground truth data 906 may be generated using the process 100 and/or within a drawing program (e.g., an annotation program), a computer aided design (CAD) program, a labeling program, another type of program suitable for generating the ground truth data 906, and/or may be hand drawn, in some examples. In any example, the ground truth data 906 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer). In some examples, for each input image, there may be corresponding ground truth data 906.

A training engine 910 may include one or more loss functions that measure loss (e.g., error) in the outputs 912 as compared to the ground truth data 906. Any type of loss function may be used, such as cross entropy loss, mean squared error, mean absolute error, mean bias error, and/or other loss function types. In some embodiments, different outputs 912 may have different loss functions. In such examples, the loss functions may be combined to form a total loss, and the total loss may be used to train (e.g., update the parameters of) the machine learning model(s) 902. In any example, backward pass computations may be performed to recursively compute gradients of the loss function(s) with respect to training parameters. In some examples, weight and biases of the machine learning model(s) may be used to compute these gradients.

In some examples, the machine learning model(s) 902 may include any model that is configured to perform one or more of the tasks described herein. For example, the machine learning model(s) 902 may include a feedforward neural network, a perceptron neural network, a multilayer perceptron neural network, a recurrent neural network, a convolution neural network, a deep stacking neural network, a large language model, and/or any other type of network.

For example, the machine learning model(s) 902 may include a number of layers. For instance, one or more of the layers may include an input layer. The input layer may hold values associated with the sensor data 904. For example, when the sensor data 904 is an image(s), the input layer may hold values representative of the raw pixel values of the image(s) as a volume (e.g., a width, W, a height, H, and color channels, C (e.g., RGB), such as 32.times.32.times.3), and/or a batch size, B (e.g., where batching is used).

One or more layers may include convolutional layers. The convolutional layers may compute the output of neurons that are connected to local regions in an input layer (e.g., the input layer), each neuron computing a dot product between their weights and a small region they are connected to in the input volume. A result of a convolutional layer may be another volume, with one of the dimensions based on the number of filters applied (e.g., the width, the height, and the number of filters, such as 32.times.32.times.12, if 12 were the number of filters).

One or more of the layers may include a rectified linear unit (ReLU) layer. The ReLU layer(s) may apply an elementwise activation function, such as the max (0, x), thresholding at zero, for example. The resulting volume of a ReLU layer may be the same as the volume of the input of the ReLU layer.

One or more of the layers may include a pooling layer. The pooling layer may perform a down-sampling operation along the spatial dimensions (e.g., the height and the width), which may result in a smaller volume than the input of the pooling layer (e.g., 16.times.16.times.12 from the 32.times.32.times.12 input volume). In some examples, the machine learning model(s) 138 may not include any pooling layers. In such examples, other types of convolution layers may be used in place of pooling layers.

One or more of the layers may include a fully connected layer. Each neuron in the fully connected layer(s) may be connected to each of the neurons in the previous volume. The fully connected layer may compute class scores, and the resulting volume may be 1.times.1.times.number of classes. In some examples, the machine learning model(s) 902 may include a fully connected layer, while in other examples, the fully connected layer of the machine learning model(s) 902 may be the fully connected layer to one or more feature extractor layers. In some examples, no fully connected layers may be used by the machine learning model(s) 902, in an effort to increase processing times and reduce computing resource requirements. In such examples, where no fully connected layers are used, the machine learning model(s) 902 may be referred to as a fully convolutional network.

One or more of the layers may, in some examples, include deconvolutional layer(s). However, the use of the term deconvolutional may be misleading and is not intended to be limiting. For example, the deconvolutional layer(s) may alternatively be referred to as transposed convolutional layers or fractionally strided convolutional layers. The deconvolutional layer(s) may be used to perform up-sampling on the output of a prior layer. For example, the deconvolutional layer(s) may be used to up-sample to a spatial resolution that is equal to the spatial resolution of the input images (e.g., the sensor data 904) to the machine learning model(s) 138, or used to up-sample to the input spatial resolution of a next layer.

Although input layers, convolutional layers, pooling layers, ReLU layers, deconvolutional layers, and fully connected layers are discussed herein with respect to the layers of the machine learning model (s 138, this is not intended to be limiting. For example, additional or alternative layers may be used in the machine learning model(s) 902, such as normalization layers, SoftMax layers, and/or other layer types.

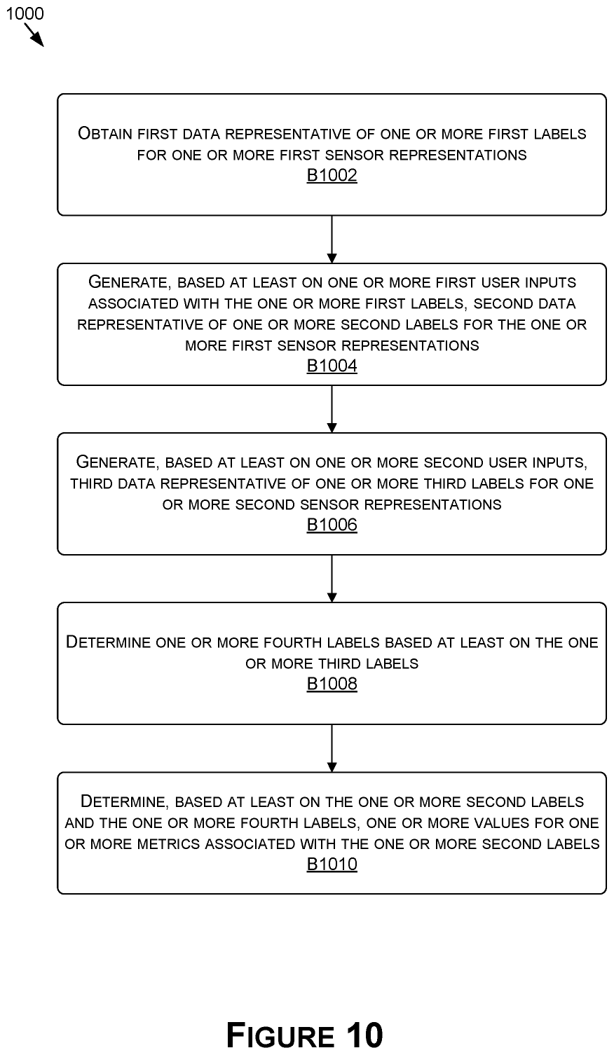

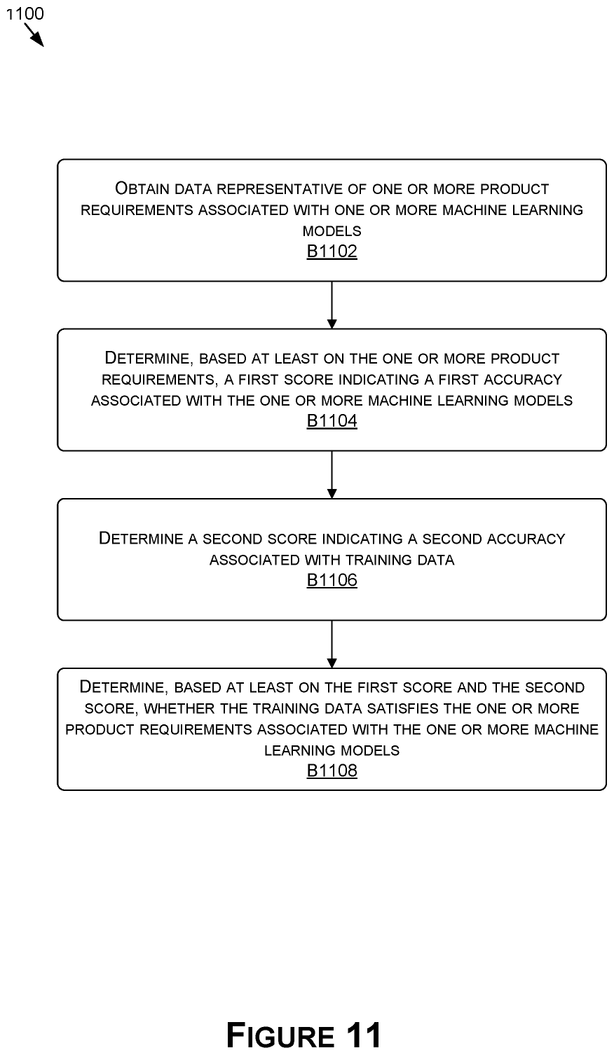

Now referring to FIGS. 10 and 11, each block of methods 1000 and 1100, described herein, comprises a computing process that may be performed using any combination of hardware, firmware, and/or software. For instance, various functions may be carried out by a processor executing instructions stored in memory. The methods 1000 and 1100 may also be embodied as computer-usable instructions stored on computer storage media. The methods 1000 and 1100 may be provided by a standalone application, a service or hosted service (standalone or in combination with another hosted service), or a plug-in to another product, to name a few. In addition, the method 1000 and 1100 are described, by way of example, with respect to FIG. 1. However, these methods 1000 and 1100 may additionally or alternatively be executed by any one system, or any combination of systems, including, but not limited to, those described herein.

FIG. 10 illustrates a flow diagram showing a method 1000 for evaluating labels associated with sensor representations, in accordance with some embodiments of the present disclosure. The method 1000, at block B1002, may include obtaining first data representative of one or more first labels for one or more first sensor representations. For instance, a system(s) (e.g., the data center(s) 1400) may use the labeling component 106 to determine the first label(s) associated with the first sensor representation(s). As described herein, the labeling component 106 may process the sensor data 104 representing the first sensor representation(s) using one or more machine learning models, one or more neural networks, one or more algorithms, one or more modules, and/or any other component that is configured to perform object detection, object tracking, object recognition, and/or any other sensor processing techniques. As described herein, a label for a sensor representation may indicate at least a location of an object as represented by the sensor representation and/or a classification associated with the object.

The method 1000, at block B1004, may include generating, based at least on one or more first user inputs associated with the one or more first labels, second data representative of one or more second labels for the one or more first sensor representations. For instance, the system(s) may cause the first client device(s) 110 to present the first sensor representation(s). The first user(s) 112 may then review the first label(s) and provide the first user input(s) associated with at least verifying and/or updating the first label(s). Additionally, based at least on the first user input(s), the system(s) may generate the second data representative of the second label(s) for the first sensor representation(s).

The method 1000, at block B1006, may include generating, based at least on one or more second user inputs, one or more third labels for one or more second sensor representation(s). For instance, the system(s) may cause the second client device(s) 116 to present the second sensor representation(s), where the second sensor representation(s) are related to (e.g., include copies and/or replicas of) the first sensor representation(s) without having been labeled. The second user(s) 118 may then review the second sensor representation(s) and provide the second user input(s) associated with the third label(s). Additionally, based at least on the second user input(s), the system(s) may generate the third data representative of the third label(s) for the second sensor representation(s).

The method 1000, at block B1008, may include determining one or more fourth labels based at least on the one or more third labels. For instance, the system(s) (e.g., the consensus component 122) may generate the fourth label(s) based at least on the third label(s). As described herein, in some examples and for a fourth label, the system(s) may merge and/or combine the third label(s) for an object to generate the fourth label (e.g., the consensus label) for the object. For example, the system(s) may merge and/or combine the third label(s) by taking the average of the third label(s), the mode of the third label(s), the median of the third label(s), the third label that includes the highest UoI with respect to the other third label(s), and/or using any other technique.

The method 1000, at block B1010, may include determining, based at least on the one or more second labels and the one or more fourth labels, one or more values for one or more metrics associated with the one or more second labels. For instance, the system(s) (e.g., the evaluation component 126) may determine the value(s) for the metric(s) using the second label(s) and the fourth label(s). As described herein, the metric(s) may be associated with how accurate the second label(s) is with respect to the first sensor representation(s). In some examples, the system(s) may then use the value(s) for the metric(s) to determine one or more scores indicating one or more accuracies associated with one or more of the first user(s) 112, one or more scores indicating one or more accuracies associated with a group that includes the user(s) 112, one or more scores indicating one or more accuracies associated with training data that includes at least a portion of the first sensor representation(s), and/or to perform any other evaluation.

FIG. 11 illustrates a flow diagram showing a method 1100 for evaluating training data to determine whether the training data is satisfactory for training one or more machine learning models, in accordance with some embodiments of the present disclosure. The method 1100, at block B1102, may include obtaining data representative of one or more product requirements associated with one or more machine learning models. For instance, the system(s) (e.g., the evaluation component 126) may obtain the requirements data 130 associated with the machine learning model(s). As described herein, the requirements data 130 may represent the product requirement(s) such as one or more accuracy requirements that the machine learning model(s) should satisfy.

The method 1100, at block B1104, may include determining, based at least on the one or more product requirements, a first score indicating a first accuracy associated with the one or more machine learning models. For instance, the system(s) (e.g., the evaluation component 126) may use at least the product requirement(s) to determine the first score indicating the first accuracy that the machine learning model(s) should satisfy, such as to be included in one or more products (e.g., a machine). For instance, if the product requirement(s) indicates an accuracy percentage associated with the machine learning model(s), then the system(s) may use the accuracy percentage to determine the first score. For example, if the accuracy percentage is 99%, then the system(s) may determine the first score as including 99% accurate and/or 1% inaccurate.

The method 1100, at block B1106, may include determining a second score indicating a second accuracy associated with training data. For instance, the system(s) (e.g., the evaluation component 126) may determine the second score indicating the second accuracy associated with the training data. In some examples, the system(s) determines the second score using at least the labeled sensor data 114 and the consensus label data 124 associated with sensor representations included in the training data. For example, the system(s) may use the consensus label data 124 to determine a number and/or a type of errors associated with the labels represented by the labeled sensor data 114. The system(s) may then determine the second score based at least on the number and/or the type of errors.

The method 1100, at block B1108, may include determining, based at least on the first score and the second score, whether the training data satisfies the one or more product requirements associated with the one or more machine learning models. For instance, the system(s) (e.g., the evaluation component 126) may use at least the first score and the second score to determine whether the training data satisfies the product requirement(s) associated with the machine learning model(s). For a first example, if the first score indicates an accuracy requirement percentage associated with the machine learning model(s) and the second score indicates an accuracy percentage associated with the training data, then the system(s) may determine that the training data satisfies the product requirement(s) based at least on the second score being equal to or greater than the first score. For a second example, if the first score indicates an inaccuracy requirement percentage associated with the machine learning model(s) and the second score indicates an inaccuracy percentage associated with the training data, then the system(s) may determine that the training data satisfies the product requirement(s) based at least on the second score being less than or equal to the first score.

### Example Autonomous Vehicle

FIG. 12A is an illustration of an example autonomous vehicle 1200, in accordance with some embodiments of the present disclosure. The autonomous vehicle 1200 (alternatively referred to herein as the “vehicle 1200”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1200 may be capable of functionality in accordance with one or more of Level 3-Level 5 of the autonomous driving levels. The vehicle 1200 may be capable of functionality in accordance with one or more of Level 1-Level 5 of the autonomous driving levels. For example, the vehicle 1200 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1200 or other machine, such as being fully autonomous, being highly autonomous, being conditionally autonomous, being partially autonomous, providing assistive autonomy, being semi-autonomous, being primarily autonomous, or other designation.

The vehicle 1200 may include components such as a chassis, a vehicle body, wheels (e.g., 2, 4, 6, 8, 18, etc.), tires, axles, and other components of a vehicle. The vehicle 1200 may include a propulsion system 1250, such as an internal combustion engine, hybrid electric power plant, an all-electric engine, and/or another propulsion system type. The propulsion system 1250 may be connected to a drive train of the vehicle 1200, which may include a transmission, to enable the propulsion of the vehicle 1200. The propulsion system 1250 may be controlled in response to receiving signals from the throttle/accelerator 1252.

A steering system 1254, which may include a steering wheel, may be used to steer the vehicle 1200 (e.g., along a desired path or route) when the propulsion system 1250 is operating (e.g., when the vehicle is in motion). The steering system 1254 may receive signals from a steering actuator 1256. The steering wheel may be optional for full automation (Level 5) functionality.

The brake sensor system 1246 may be used to operate the vehicle brakes in response to receiving signals from the brake actuators 1248 and/or brake sensors.

Controller(s) 1236, which may include one or more system on chips (SoCs) 1204 (FIG. 12C) and/or GPU(s), may provide signals (e.g., representative of commands) to one or more components and/or systems of the vehicle 1200. For example, the controller(s) may send signals to operate the vehicle brakes via one or more brake actuators 1248, to operate the steering system 1254 via one or more steering actuators 1256, to operate the propulsion system 1250 via one or more throttle/accelerators 1252. The controller(s) 1236 may include one or more onboard (e.g., integrated) computing devices (e.g., supercomputers) that process sensor signals, and output operation commands (e.g., signals representing commands) to enable autonomous driving and/or to assist a human driver in driving the vehicle 1200. The controller(s) 1236 may include a first controller 1236 for autonomous driving functions, a second controller 1236 for functional safety functions, a third controller 1236 for artificial intelligence functionality (e.g., computer vision), a fourth controller 1236 for infotainment functionality, a fifth controller 1236 for redundancy in emergency conditions, and/or other controllers. In some examples, a single controller 1236 may handle two or more of the above functionalities, two or more controllers 1236 may handle a single functionality, and/or any combination thereof.

The controller(s) 1236 may provide the signals for controlling one or more components and/or systems of the vehicle 1200 in response to sensor data received from one or more sensors (e.g., sensor inputs). The sensor data may be received from, for example and without limitation, global navigation satellite systems (“GNSS”) sensor(s) 1258 (e.g., Global Positioning System sensor(s)), RADAR sensor(s) 1260, ultrasonic sensor(s) 1262, LIDAR sensor(s) 1264, inertial measurement unit (IMU) sensor(s) 1266 (e.g., accelerometer(s), gyroscope(s), magnetic compass(es), magnetometer(s), etc.), microphone(s) 1296, stereo camera(s) 1268, wide-view camera(s) 1270 (e.g., fisheye cameras), infrared camera(s) 1272, surround camera(s) 1274 (e.g., 360 degree cameras), long-range and/or mid-range camera(s) 1298, speed sensor(s) 1244 (e.g., for measuring the speed of the vehicle 1200), vibration sensor(s) 1242, steering sensor(s) 1240, brake sensor(s) (e.g., as part of the brake sensor system 1246), and/or other sensor types.

One or more of the controller(s) 1236 may receive inputs (e.g., represented by input data) from an instrument cluster 1232 of the vehicle 1200 and provide outputs (e.g., represented by output data, display data, etc.) via a human-machine interface (HMI) display 1234, an audible annunciator, a loudspeaker, and/or via other components of the vehicle 1200. The outputs may include information such as vehicle velocity, speed, time, map data (e.g., the High Definition (“HD”) map 1222 of FIG. 12C), location data (e.g., the vehicle's 1200 location, such as on a map), direction, location of other vehicles (e.g., an occupancy grid), information about objects and status of objects as perceived by the controller(s) 1236, etc. For example, the HMI display 1234 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1200 further includes a network interface 1224 which may use one or more wireless antenna(s) 1226 and/or modem(s) to communicate over one or more networks. For example, the network interface 1224 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1226 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 12B is an example of camera locations and fields of view for the example autonomous vehicle 1200 of FIG. 12A, in accordance with some embodiments of the present disclosure. The cameras and respective fields of view are one example embodiment and are not intended to be limiting. For example, additional and/or alternative cameras may be included and/or the cameras may be located at different locations on the vehicle 1200.

The camera types for the cameras may include, but are not limited to, digital cameras that may be adapted for use with the components and/or systems of the vehicle 1200. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1200 (e.g., front-facing cameras) may be used for surround view, to help identify forward facing paths and obstacles, as well aid in, with the help of one or more controllers 1236 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1270 that may be used to perceive objects coming into view from the periphery (e.g., pedestrians, crossing traffic or bicycles). Although only one wide-view camera is illustrated in FIG. 12B, there may be any number (including zero) of wide-view cameras 1270 on the vehicle 1200. In addition, any number of long-range camera(s) 1298 (e.g., a long-view stereo camera pair) may be used for depth-based object detection, especially for objects for which a neural network has not yet been trained. The long-range camera(s) 1298 may also be used for object detection and classification, as well as basic object tracking.

Any number of stereo cameras 1268 may also be included in a front-facing configuration. In at least one embodiment, one or more of stereo camera(s) 1268 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1268 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1268 may be used in addition to, or alternatively from, those described herein.

Cameras with a field of view that include portions of the environment to the side of the vehicle 1200 (e.g., side-view cameras) may be used for surround view, providing information used to create and update the occupancy grid, as well as to generate side impact collision warnings. For example, surround camera(s) 1274 (e.g., four surround cameras 1274 as illustrated in FIG. 12B) may be positioned to on the vehicle 1200. The surround camera(s) 1274 may include wide-view camera(s) 1270, fisheye camera(s), 360 degree camera(s), and/or the like. Four example, four fisheye cameras may be positioned on the vehicle's front, rear, and sides. In an alternative arrangement, the vehicle may use three surround camera(s) 1274 (e.g., left, right, and rear), and may leverage one or more other camera(s) (e.g., a forward-facing camera) as a fourth surround view camera.

Cameras with a field of view that include portions of the environment to the rear of the vehicle 1200 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1298, stereo camera(s) 1268), infrared camera(s) 1272, etc.), as described herein.

FIG. 12C is a block diagram of an example system architecture for the example autonomous vehicle 1200 of FIG. 12A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1200 in FIG. 12C are illustrated as being connected via bus 1202. The bus 1202 may include a Controller Area Network (CAN) data interface (alternatively referred to herein as a “CAN bus”). A CAN may be a network inside the vehicle 1200 used to aid in control of various features and functionality of the vehicle 1200, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1202 is described herein as being a CAN bus, this is not intended to be limiting. For example, in addition to, or alternatively from, the CAN bus, FlexRay and/or Ethernet may be used. Additionally, although a single line is used to represent the bus 1202, this is not intended to be limiting. For example, there may be any number of busses 1202, which may include one or more CAN busses, one or more FlexRay busses, one or more Ethernet busses, and/or one or more other types of busses using a different protocol. In some examples, two or more busses 1202 may be used to perform different functions, and/or may be used for redundancy. For example, a first bus 1202 may be used for collision avoidance functionality and a second bus 1202 may be used for actuation control. In any example, each bus 1202 may communicate with any of the components of the vehicle 1200, and two or more busses 1202 may communicate with the same components. In some examples, each SoC 1204, each controller 1236, and/or each computer within the vehicle may have access to the same input data (e.g., inputs from sensors of the vehicle 1200), and may be connected to a common bus, such the CAN bus.

The vehicle 1200 may include one or more controller(s) 1236, such as those described herein with respect to FIG. 12A. The controller(s) 1236 may be used for a variety of functions. The controller(s) 1236 may be coupled to any of the various other components and systems of the vehicle 1200, and may be used for control of the vehicle 1200, artificial intelligence of the vehicle 1200, infotainment for the vehicle 1200, and/or the like.

The vehicle 1200 may include a system(s) on a chip (SoC) 1204. The SoC 1204 may include CPU(s) 1206, GPU(s) 1208, processor(s) 1210, cache(s) 1212, accelerator(s) 1214, data store(s) 1216, and/or other components and features not illustrated. The SoC(s) 1204 may be used to control the vehicle 1200 in a variety of platforms and systems. For example, the SoC(s) 1204 may be combined in a system (e.g., the system of the vehicle 1200) with an HD map 1222 which may obtain map refreshes and/or updates via a network interface 1224 from one or more servers (e.g., server(s) 1278 of FIG. 12D).

The CPU(s) 1206 may include a CPU cluster or CPU complex (alternatively referred to herein as a “CCPLEX”). The CPU(s) 1206 may include multiple cores and/or L2 caches. For example, in some embodiments, the CPU(s) 1206 may include eight cores in a coherent multi-processor configuration. In some embodiments, the CPU(s) 1206 may include four dual-core clusters where each cluster has a dedicated L2 cache (e.g., a 2 MB L2 cache). The CPU(s) 1206 (e.g., the CCPLEX) may be configured to support simultaneous cluster operation enabling any combination of the clusters of the CPU(s) 1206 to be active at any given time.

The CPU(s) 1206 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1206 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1208 may include an integrated GPU (alternatively referred to herein as an “iGPU”). The GPU(s) 1208 may be programmable and may be efficient for parallel workloads. The GPU(s) 1208, in some examples, may use an enhanced tensor instruction set. The GPU(s) 1208 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1208 may include at least eight streaming microprocessors. The GPU(s) 1208 may use compute application programming interface(s) (API(s)). In addition, the GPU(s) 1208 may use one or more parallel computing platforms and/or programming models (e.g., NVIDIA's CUDA).

The GPU(s) 1208 may be power-optimized for best performance in automotive and embedded use cases. For example, the GPU(s) 1208 may be fabricated on a Fin field-effect transistor (FinFET). However, this is not intended to be limiting and the GPU(s) 1208 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1208 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1208 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1208 to access the CPU(s) 1206 page tables directly. In such examples, when the GPU(s) 1208 memory management unit (MMU) experiences a miss, an address translation request may be transmitted to the CPU(s) 1206. In response, the CPU(s) 1206 may look in its page tables for the virtual-to-physical mapping for the address and transmits the translation back to the GPU(s) 1208. As such, unified memory technology may allow a single unified virtual address space for memory of both the CPU(s) 1206 and the GPU(s) 1208, thereby simplifying the GPU(s) 1208 programming and porting of applications to the GPU(s) 1208.

In addition, the GPU(s) 1208 may include an access counter that may keep track of the frequency of access of the GPU(s) 1208 to memory of other processors. The access counter may help ensure that memory pages are moved to the physical memory of the processor that is accessing the pages most frequently.

The SoC(s) 1204 may include any number of cache(s) 1212, including those described herein. For example, the cache(s) 1212 may include an L3 cache that is available to both the CPU(s) 1206 and the GPU(s) 1208 (e.g., that is connected both the CPU(s) 1206 and the GPU(s) 1208). The cache(s) 1212 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1204 may include an arithmetic logic unit(s) (ALU(s)) which may be leveraged in performing processing with respect to any of the variety of tasks or operations of the vehicle 1200—such as processing DNNs. In addition, the SoC(s) 1204 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1206 and/or GPU(s) 1208.

The SoC(s) 1204 may include one or more accelerators 1214 (e.g., hardware accelerators, software accelerators, or a combination thereof). For example, the SoC(s) 1204 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1208 and to off-load some of the tasks of the GPU(s) 1208 (e.g., to free up more cycles of the GPU(s) 1208 for performing other tasks). As an example, the accelerator(s) 1214 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1214 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1208, and by using an inference accelerator, for example, a designer may target either the DLA(s) or the GPU(s) 1208 for any function. For example, the designer may focus processing of CNNs and floating point operations on the DLA(s) and leave other functions to the GPU(s) 1208 and/or other accelerator(s) 1214.

The accelerator(s) 1214 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1206. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1214 (e.g., the hardware acceleration cluster) may include a computer vision network on-chip and SRAM, for providing a high-bandwidth, low latency SRAM for the accelerator(s) 1214. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1204 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1214 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1266 output that correlates with the vehicle 1200 orientation, distance, 3D location estimates of the object obtained from the neural network and/or other sensors (e.g., LIDAR sensor(s) 1264 or RADAR sensor(s) 1260), among others.

The SoC(s) 1204 may include data store(s) 1216 (e.g., memory). The data store(s) 1216 may be on-chip memory of the SoC(s) 1204, which may store neural networks to be executed on the GPU and/or the DLA. In some examples, the data store(s) 1216 may be large enough in capacity to store multiple instances of neural networks for redundancy and safety. The data store(s) 1212 may comprise L2 or L3 cache(s) 1212. Reference to the data store(s) 1216 may include reference to the memory associated with the PVA, DLA, and/or other accelerator(s) 1214, as described herein.

The SoC(s) 1204 may include one or more processor(s) 1210 (e.g., embedded processors). The processor(s) 1210 may include a boot and power management processor that may be a dedicated processor and subsystem to handle boot power and management functions and related security enforcement. The boot and power management processor may be a part of the SoC(s) 1204 boot sequence and may provide runtime power management services. The boot power and management processor may provide clock and voltage programming, assistance in system low power state transitions, management of SoC(s) 1204 thermals and temperature sensors, and/or management of the SoC(s) 1204 power states. Each temperature sensor may be implemented as a ring-oscillator whose output frequency is proportional to temperature, and the SoC(s) 1204 may use the ring-oscillators to detect temperatures of the CPU(s) 1206, GPU(s) 1208, and/or accelerator(s) 1214. If temperatures are determined to exceed a threshold, the boot and power management processor may enter a temperature fault routine and put the SoC(s) 1204 into a lower power state and/or put the vehicle 1200 into a chauffeur to safe stop mode (e.g., bring the vehicle 1200 to a safe stop).

The processor(s) 1210 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1210 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1210 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1210 may further include a real-time camera engine that may include a dedicated processor subsystem for handling real-time camera management.

The processor(s) 1210 may further include a high-dynamic range signal processor that may include an image signal processor that is a hardware engine that is part of the camera processing pipeline.

The processor(s) 1210 may include a video image compositor that may be a processing block (e.g., implemented on a microprocessor) that implements video post-processing functions needed by a video playback application to produce the final image for the player window. The video image compositor may perform lens distortion correction on wide-view camera(s) 1270, surround camera(s) 1274, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1208 is not required to continuously render new surfaces. Even when the GPU(s) 1208 is powered on and active doing 3D rendering, the video image compositor may be used to offload the GPU(s) 1208 to improve performance and responsiveness.

The SoC(s) 1204 may further include a mobile industry processor interface (MIPI) camera serial interface for receiving video and input from cameras, a high-speed interface, and/or a video input block that may be used for camera and related pixel input functions. The SoC(s) 1204 may further include an input/output controller(s) that may be controlled by software and may be used for receiving I/O signals that are uncommitted to a specific role.

The SoC(s) 1204 may further include a broad range of peripheral interfaces to enable communication with peripherals, audio codecs, power management, and/or other devices. The SoC(s) 1204 may be used to process data from cameras (e.g., connected over Gigabit Multimedia Serial Link and Ethernet), sensors (e.g., LIDAR sensor(s) 1264, RADAR sensor(s) 1260, etc. that may be connected over Ethernet), data from bus 1202 (e.g., speed of vehicle 1200, steering wheel position, etc.), data from GNSS sensor(s) 1258 (e.g., connected over Ethernet or CAN bus). The SoC(s) 1204 may further include dedicated high-performance mass storage controllers that may include their own DMA engines, and that may be used to free the CPU(s) 1206 from routine data management tasks.

The SoC(s) 1204 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1204 may be faster, more reliable, and even more energy-efficient and space-efficient than conventional systems. For example, the accelerator(s) 1214, when combined with the CPU(s) 1206, the GPU(s) 1208, and the data store(s) 1216, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1220) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1208.

In some examples, a CNN for facial recognition and vehicle owner identification may use data from camera sensors to identify the presence of an authorized driver and/or owner of the vehicle 1200. The always on sensor processing engine may be used to unlock the vehicle when the owner approaches the driver door and turn on the lights, and, in security mode, to disable the vehicle when the owner leaves the vehicle. In this way, the SoC(s) 1204 provide for security against theft and/or carjacking.

In another example, a CNN for emergency vehicle detection and identification may use data from microphones 1296 to detect and identify emergency vehicle sirens. In contrast to conventional systems, that use general classifiers to detect sirens and manually extract features, the SoC(s) 1204 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1258. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1262, until the emergency vehicle(s) passes.

The vehicle may include a CPU(s) 1218 (e.g., discrete CPU(s), or dCPU(s)), that may be coupled to the SoC(s) 1204 via a high-speed interconnect (e.g., PCIe). The CPU(s) 1218 may include an X86 processor, for example. The CPU(s) 1218 may be used to perform any of a variety of functions, including arbitrating potentially inconsistent results between ADAS sensors and the SoC(s) 1204, and/or monitoring the status and health of the controller(s) 1236 and/or infotainment SoC 1230, for example.

The vehicle 1200 may include a GPU(s) 1220 (e.g., discrete GPU(s), or dGPU(s)), that may be coupled to the SoC(s) 1204 via a high-speed interconnect (e.g., NVIDIA's NVLINK). The GPU(s) 1220 may provide additional artificial intelligence functionality, such as by executing redundant and/or different neural networks, and may be used to train and/or update neural networks based on input (e.g., sensor data) from sensors of the vehicle 1200.

The vehicle 1200 may further include the network interface 1224 which may include one or more wireless antennas 1226 (e.g., one or more wireless antennas for different communication protocols, such as a cellular antenna, a Bluetooth antenna, etc.). The network interface 1224 may be used to enable wireless connectivity over the Internet with the cloud (e.g., with the server(s) 1278 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1200 information about vehicles in proximity to the vehicle 1200 (e.g., vehicles in front of, on the side of, and/or behind the vehicle 1200). This functionality may be part of a cooperative adaptive cruise control functionality of the vehicle 1200.

The network interface 1224 may include a SoC that provides modulation and demodulation functionality and enables the controller(s) 1236 to communicate over wireless networks. The network interface 1224 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1200 may further include data store(s) 1228 which may include off-chip (e.g., off the SoC(s) 1204) storage. The data store(s) 1228 may include one or more storage elements including RAM, SRAM, DRAM, VRAM, Flash, hard disks, and/or other components and/or devices that may store at least one bit of data.

The vehicle 1200 may further include GNSS sensor(s) 1258. The GNSS sensor(s) 1258 (e.g., GPS, assisted GPS sensors, differential GPS (DGPS) sensors, etc.), to assist in mapping, perception, occupancy grid generation, and/or path planning functions. Any number of GNSS sensor(s) 1258 may be used, including, for example and without limitation, a GPS using a USB connector with an Ethernet to Serial (RS-232) bridge.

The vehicle 1200 may further include RADAR sensor(s) 1260. The RADAR sensor(s) 1260 may be used by the vehicle 1200 for long-range vehicle detection, even in darkness and/or severe weather conditions. RADAR functional safety levels may be ASIL B. The RADAR sensor(s) 1260 may use the CAN and/or the bus 1202 (e.g., to transmit data generated by the RADAR sensor(s) 1260) for control and to access object tracking data, with access to Ethernet to access raw data in some examples. A wide variety of RADAR sensor types may be used. For example, and without limitation, the RADAR sensor(s) 1260 may be suitable for front, rear, and side RADAR use. In some example, Pulse Doppler RADAR sensor(s) are used.

The RADAR sensor(s) 1260 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1260 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1200 surroundings at higher speeds with minimal interference from traffic in adjacent lanes. The other two antennae may expand the field of view, making it possible to quickly detect vehicles entering or leaving the vehicle's 1200 lane.

Mid-range RADAR systems may include, as an example, a range of up to 1260 m (front) or 80 m (rear), and a field of view of up to 42 degrees (front) or 1250 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1200 may further include ultrasonic sensor(s) 1262. The ultrasonic sensor(s) 1262, which may be positioned at the front, back, and/or the sides of the vehicle 1200, may be used for park assist and/or to create and update an occupancy grid. A wide variety of ultrasonic sensor(s) 1262 may be used, and different ultrasonic sensor(s) 1262 may be used for different ranges of detection (e.g., 2.5 m, 4 m). The ultrasonic sensor(s) 1262 may operate at functional safety levels of ASIL B.

The vehicle 1200 may include LIDAR sensor(s) 1264. The LIDAR sensor(s) 1264 may be used for object and pedestrian detection, emergency braking, collision avoidance, and/or other functions. The LIDAR sensor(s) 1264 may be functional safety level ASIL B. In some examples, the vehicle 1200 may include multiple LIDAR sensors 1264 (e.g., two, four, six, etc.) that may use Ethernet (e.g., to provide data to a Gigabit Ethernet switch).

In some examples, the LIDAR sensor(s) 1264 may be capable of providing a list of objects and their distances for a 360-degree field of view. Commercially available LIDAR sensor(s) 1264 may have an advertised range of approximately 1200 m, with an accuracy of 2 cm-3 cm, and with support for a 1200 Mbps Ethernet connection, for example. In some examples, one or more non-protruding LIDAR sensors 1264 may be used. In such examples, the LIDAR sensor(s) 1264 may be implemented as a small device that may be embedded into the front, rear, sides, and/or corners of the vehicle 1200. The LIDAR sensor(s) 1264, in such examples, may provide up to a 120-degree horizontal and 35-degree vertical field-of-view, with a 200 m range even for low-reflectivity objects. Front-mounted LIDAR sensor(s) 1264 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1200. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1264 may be less susceptible to motion blur, vibration, and/or shock.

The vehicle may further include IMU sensor(s) 1266. The IMU sensor(s) 1266 may be located at a center of the rear axle of the vehicle 1200, in some examples. The IMU sensor(s) 1266 may include, for example and without limitation, an accelerometer(s), a magnetometer(s), a gyroscope(s), a magnetic compass(es), and/or other sensor types. In some examples, such as in six-axis applications, the IMU sensor(s) 1266 may include accelerometers and gyroscopes, while in nine-axis applications, the IMU sensor(s) 1266 may include accelerometers, gyroscopes, and magnetometers.

In some embodiments, the IMU sensor(s) 1266 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1266 may enable the vehicle 1200 to estimate heading without requiring input from a magnetic sensor by directly observing and correlating the changes in velocity from GPS to the IMU sensor(s) 1266. In some examples, the IMU sensor(s) 1266 and the GNSS sensor(s) 1258 may be combined in a single integrated unit.

The vehicle may include microphone(s) 1296 placed in and/or around the vehicle 1200. The microphone(s) 1296 may be used for emergency vehicle detection and identification, among other things.

The vehicle may further include any number of camera types, including stereo camera(s) 1268, wide-view camera(s) 1270, infrared camera(s) 1272, surround camera(s) 1274, long-range and/or mid-range camera(s) 1298, and/or other camera types. The cameras may be used to capture image data around an entire periphery of the vehicle 1200. The types of cameras used depends on the embodiments and requirements for the vehicle 1200, and any combination of camera types may be used to provide the necessary coverage around the vehicle 1200. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 12A and FIG. 12B.

The vehicle 1200 may further include vibration sensor(s) 1242. The vibration sensor(s) 1242 may measure vibrations of components of the vehicle, such as the axle(s). For example, changes in vibrations may indicate a change in road surfaces. In another example, when two or more vibration sensors 1242 are used, the differences between the vibrations may be used to determine friction or slippage of the road surface (e.g., when the difference in vibration is between a power-driven axle and a freely rotating axle).

The vehicle 1200 may include an ADAS system 1238. The ADAS system 1238 may include a SoC, in some examples. The ADAS system 1238 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1260, LIDAR sensor(s) 1264, and/or a camera(s). The ACC systems may include longitudinal ACC and/or lateral ACC. Longitudinal ACC monitors and controls the distance to the vehicle immediately ahead of the vehicle 1200 and automatically adjust the vehicle speed to maintain a safe distance from vehicles ahead. Lateral ACC performs distance keeping, and advises the vehicle 1200 to change lanes when necessary. Lateral ACC is related to other ADAS applications such as LCA and CWS.

CACC uses information from other vehicles that may be received via the network interface 1224 and/or the wireless antenna(s) 1226 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1200), while the I2V communication concept provides information about traffic further ahead. CACC systems may include either or both I2V and V2V information sources. Given the information of the vehicles ahead of the vehicle 1200, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1260, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1260, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1200 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1200 if the vehicle 1200 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1260, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1200 is backing up. Some RCTW systems include AEB to ensure that the vehicle brakes are applied to avoid a crash. RCTW systems may use one or more rear-facing RADAR sensor(s) 1260, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1200, the vehicle 1200 itself must, in the case of conflicting results, decide whether to heed the result from a primary computer or a secondary computer (e.g., a first controller 1236 or a second controller 1236). For example, in some embodiments, the ADAS system 1238 may be a backup and/or secondary computer for providing perception information to a backup computer rationality module. The backup computer rationality monitor may run a redundant diverse software on hardware components to detect faults in perception and dynamic driving tasks. Outputs from the ADAS system 1238 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1204.

In other examples, ADAS system 1238 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1238 may be fed into the primary computer's perception block and/or the primary computer's dynamic driving task block. For example, if the ADAS system 1238 indicates a forward crash warning due to an object immediately ahead, the perception block may use this information when identifying objects. In other examples, the secondary computer may have its own neural network which is trained and thus reduces the risk of false positives, as described herein.

The vehicle 1200 may further include the infotainment SoC 1230 (e.g., an in-vehicle infotainment system (IVI)). Although illustrated and described as a SoC, the infotainment system may not be a SoC, and may include two or more discrete components. The infotainment SoC 1230 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1200. For example, the infotainment SoC 1230 may radios, disk players, navigation systems, video players, USB and Bluetooth connectivity, carputers, in-car entertainment, Wi-Fi, steering wheel audio controls, hands free voice control, a heads-up display (HUD), an HMI display 1234, a telematics device, a control panel (e.g., for controlling and/or interacting with various components, features, and/or systems), and/or other components. The infotainment SoC 1230 may further be used to provide information (e.g., visual and/or audible) to a user(s) of the vehicle, such as information from the ADAS system 1238, autonomous driving information such as planned vehicle maneuvers, trajectories, surrounding environment information (e.g., intersection information, vehicle information, road information, etc.), and/or other information.

The infotainment SoC 1230 may include GPU functionality. The infotainment SoC 1230 may communicate over the bus 1202 (e.g., CAN bus, Ethernet, etc.) with other devices, systems, and/or components of the vehicle 1200. In some examples, the infotainment SoC 1230 may be coupled to a supervisory MCU such that the GPU of the infotainment system may perform some self-driving functions in the event that the primary controller(s) 1236 (e.g., the primary and/or backup computers of the vehicle 1200) fail. In such an example, the infotainment SoC 1230 may put the vehicle 1200 into a chauffeur to safe stop mode, as described herein.

The vehicle 1200 may further include an instrument cluster 1232 (e.g., a digital dash, an electronic instrument cluster, a digital instrument panel, etc.). The instrument cluster 1232 may include a controller and/or supercomputer (e.g., a discrete controller or supercomputer). The instrument cluster 1232 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1230 and the instrument cluster 1232. In other words, the instrument cluster 1232 may be included as part of the infotainment SoC 1230, or vice versa.

FIG. 12D is a system diagram for communication between cloud-based server(s) and the example autonomous vehicle 1200 of FIG. 12A, in accordance with some embodiments of the present disclosure. The system 1276 may include server(s) 1278, network(s) 1290, and vehicles, including the vehicle 1200. The server(s) 1278 may include a plurality of GPUs 1284(A)-1284 (H) (collectively referred to herein as GPUs 1284), PCIe switches 1282(A)-1282(H) (collectively referred to herein as PCIe switches 1282), and/or CPUs 1280(A)-1280(B) (collectively referred to herein as CPUs 1280). The GPUs 1284, the CPUs 1280, and the PCIe switches may be interconnected with high-speed interconnects such as, for example and without limitation, NVLink interfaces 1288 developed by NVIDIA and/or PCIe connections 1286. In some examples, the GPUs 1284 are connected via NVLink and/or NVSwitch SoC and the GPUs 1284 and the PCIe switches 1282 are connected via PCIe interconnects. Although eight GPUs 1284, two CPUs 1280, and two PCIe switches are illustrated, this is not intended to be limiting. Depending on the embodiment, each of the server(s) 1278 may include any number of GPUs 1284, CPUs 1280, and/or PCIe switches. For example, the server(s) 1278 may each include eight, sixteen, thirty-two, and/or more GPUs 1284.

The server(s) 1278 may receive, over the network(s) 1290 and from the vehicles, image data representative of images showing unexpected or changed road conditions, such as recently commenced road-work. The server(s) 1278 may transmit, over the network(s) 1290 and to the vehicles, neural networks 1292, updated neural networks 1292, and/or map information 1294, including information regarding traffic and road conditions. The updates to the map information 1294 may include updates for the HD map 1222, such as information regarding construction sites, potholes, detours, flooding, and/or other obstructions. In some examples, the neural networks 1292, the updated neural networks 1292, and/or the map information 1294 may have resulted from new training and/or experiences represented in data received from any number of vehicles in the environment, and/or based on training performed at a datacenter (e.g., using the server(s) 1278 and/or other servers).

The server(s) 1278 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1290, and/or the machine learning models may be used by the server(s) 1278 to remotely monitor the vehicles.

In some examples, the server(s) 1278 may receive data from the vehicles and apply the data to up-to-date real-time neural networks for real-time intelligent inferencing. The server(s) 1278 may include deep-learning supercomputers and/or dedicated AI computers powered by GPU(s) 1284, such as a DGX and DGX Station machines developed by NVIDIA. However, in some examples, the server(s) 1278 may include deep learning infrastructure that use only CPU-powered datacenters.

The deep-learning infrastructure of the server(s) 1278 may be capable of fast, real-time inferencing, and may use that capability to evaluate and verify the health of the processors, software, and/or associated hardware in the vehicle 1200. For example, the deep-learning infrastructure may receive periodic updates from the vehicle 1200, such as a sequence of images and/or objects that the vehicle 1200 has located in that sequence of images (e.g., via computer vision and/or other machine learning object classification techniques). The deep-learning infrastructure may run its own neural network to identify the objects and compare them with the objects identified by the vehicle 1200 and, if the results do not match and the infrastructure concludes that the AI in the vehicle 1200 is malfunctioning, the server(s) 1278 may transmit a signal to the vehicle 1200 instructing a fail-safe computer of the vehicle 1200 to assume control, notify the passengers, and complete a safe parking maneuver.

For inferencing, the server(s) 1278 may include the GPU(s) 1284 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 13 is a block diagram of an example computing device(s) 1300 suitable for use in implementing some embodiments of the present disclosure. Computing device 1300 may include an interconnect system 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, one or more presentation components 1318 (e.g., display(s)), and one or more logic units 1320. In at least one embodiment, the computing device(s) 1300 may comprise one or more virtual machines (VMs), and/or any of the components thereof may comprise virtual components (e.g., virtual hardware components). For non-limiting examples, one or more of the GPUs 1308 may comprise one or more vGPUs, one or more of the CPUs 1306 may comprise one or more vCPUs, and/or one or more of the logic units 1320 may comprise one or more virtual logic units. As such, a computing device(s) 1300 may include discrete components (e.g., a full GPU dedicated to the computing device 1300), virtual components (e.g., a portion of a GPU dedicated to the computing device 1300), or a combination thereof.

Although the various blocks of FIG. 13 are shown as connected via the interconnect system 1302 with lines, this is not intended to be limiting and is for clarity only. For example, in some embodiments, a presentation component 1318, such as a display device, may be considered an I/O component 1314 (e.g., if the display is a touch screen). As another example, the CPUs 1306 and/or GPUs 1308 may include memory (e.g., the memory 1304 may be representative of a storage device in addition to the memory of the GPUs 1308, the CPUs 1306, and/or other components). In other words, the computing device of FIG. 13 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 13.

The interconnect system 1302 may represent one or more links or busses, such as an address bus, a data bus, a control bus, or a combination thereof. The interconnect system 1302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1306 may be directly connected to the memory 1304. Further, the CPU 1306 may be directly connected to the GPU 1308. Where there is direct, or point-to-point connection between components, the interconnect system 1302 may include a PCIe link to carry out the connection. In these examples, a PCI bus need not be included in the computing device 1300.

The memory 1304 may include any of a variety of computer-readable media. The computer-readable media may be any available media that may be accessed by the computing device 1300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1306 may be configured to execute at least some of the computer-readable instructions to control one or more components of the computing device 1300 to perform one or more of the methods and/or processes described herein. The CPU(s) 1306 may each include one or more cores (e.g., one, two, four, eight, twenty-eight, seventy-two, etc.) that are capable of handling a multitude of software threads simultaneously. The CPU(s) 1306 may include any type of processor, and may include different types of processors depending on the type of computing device 1300 implemented (e.g., processors with fewer cores for mobile devices and processors with more cores for servers). For example, depending on the type of computing device 1300, the processor may be an Advanced RISC Machines (ARM) processor implemented using Reduced Instruction Set Computing (RISC) or an x86 processor implemented using Complex Instruction Set Computing (CISC). The computing device 1300 may include one or more CPUs 1306 in addition to one or more microprocessors or supplementary co-processors, such as math co-processors.

In addition to or alternatively from the CPU(s) 1306, the GPU(s) 1308 may be configured to execute at least some of the computer-readable instructions to control one or more components of the computing device 1300 to perform one or more of the methods and/or processes described herein. One or more of the GPU(s) 1308 may be an integrated GPU (e.g., with one or more of the CPU(s) 1306 and/or one or more of the GPU(s) 1308 may be a discrete GPU. In embodiments, one or more of the GPU(s) 1308 may be a coprocessor of one or more of the CPU(s) 1306. The GPU(s) 1308 may be used by the computing device 1300 to render graphics (e.g., 3D graphics) or perform general purpose computations. For example, the GPU(s) 1308 may be used for General-Purpose computing on GPUs (GPGPU). The GPU(s) 1308 may include hundreds or thousands of cores that are capable of handling hundreds or thousands of software threads simultaneously. The GPU(s) 1308 may generate pixel data for output images in response to rendering commands (e.g., rendering commands from the CPU(s) 1306 received via a host interface). The GPU(s) 1308 may include graphics memory, such as display memory, for storing pixel data or any other suitable data, such as GPGPU data. The display memory may be included as part of the memory 1304. The GPU(s) 1308 may include two or more GPUs operating in parallel (e.g., via a link). The link may directly connect the GPUs (e.g., using NVLINK) or may connect the GPUs through a switch (e.g., using NVSwitch). When combined together, each GPU 1308 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1306 and/or the GPU(s) 1308, the logic unit(s) 1320 may be configured to execute at least some of the computer-readable instructions to control one or more components of the computing device 1300 to perform one or more of the methods and/or processes described herein. In embodiments, the CPU(s) 1306, the GPU(s) 1308, and/or the logic unit(s) 1320 may discretely or jointly perform any combination of the methods, processes and/or portions thereof. One or more of the logic units 1320 may be part of and/or integrated in one or more of the CPU(s) 1306 and/or the GPU(s) 1308 and/or one or more of the logic units 1320 may be discrete components or otherwise external to the CPU(s) 1306 and/or the GPU(s) 1308. In embodiments, one or more of the logic units 1320 may be a coprocessor of one or more of the CPU(s) 1306 and/or one or more of the GPU(s) 1308.

Examples of the logic unit(s) 1320 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1310 may include one or more receivers, transmitters, and/or transceivers that enable the computing device 1300 to communicate with other computing devices via an electronic communication network, included wired and/or wireless communications. The communication interface 1310 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1320 and/or communication interface 1310 may include one or more data processing units (DPUs) to transmit data received over a network and/or through interconnect system 1302 directly to (e.g., a memory of) one or more GPU(s) 1308.

The I/O ports 1312 may enable the computing device 1300 to be logically coupled to other devices including the I/O components 1314, the presentation component(s) 1318, and/or other components, some of which may be built in to (e.g., integrated in) the computing device 1300. Illustrative I/O components 1314 include a microphone, mouse, keyboard, joystick, game pad, game controller, satellite dish, scanner, printer, wireless device, etc. The I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1300. The computing device 1300 may be include depth cameras, such as stereoscopic camera systems, infrared camera systems, RGB camera systems, touchscreen technology, and combinations of these, for gesture detection and recognition. Additionally, the computing device 1300 may include accelerometers or gyroscopes (e.g., as part of an inertia measurement unit (IMU)) that enable detection of motion. In some examples, the output of the accelerometers or gyroscopes may be used by the computing device 1300 to render immersive augmented reality or virtual reality.

The power supply 1316 may include a hard-wired power supply, a battery power supply, or a combination thereof. The power supply 1316 may provide power to the computing device 1300 to enable the components of the computing device 1300 to operate.

The presentation component(s) 1318 may include a display (e.g., a monitor, a touch screen, a television screen, a heads-up-display (HUD), other display types, or a combination thereof), speakers, and/or other presentation components. The presentation component(s) 1318 may receive data from other components (e.g., the GPU(s) 1308, the CPU(s) 1306, DPUs, etc.), and output the data (e.g., as an image, video, sound, etc.).

### Example Data Center

FIG. 14 illustrates an example data center 1400 that may be used in at least one embodiments of the present disclosure. The data center 1400 may include a data center infrastructure layer 1410, a framework layer 1420, a software layer 1430, and/or an application layer 1440.

As shown in FIG. 14, the data center infrastructure layer 1410 may include a resource orchestrator 1412, grouped computing resources 1414, and node computing resources (“node C.R.s”) 1416(1)-1416(N), where “N” represents any whole, positive integer. In at least one embodiment, node C.R.s 1416(1)-1416(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1416(1)-1416(N) may correspond to a server having one or more of the above-mentioned computing resources. In addition, in some embodiments, the node C.R.s 1416(1)-14161 (N) may include one or more virtual components, such as vGPUs, vCPUs, and/or the like, and/or one or more of the node C.R.s 1416(1)-1416(N) may correspond to a virtual machine (VM).

In at least one embodiment, grouped computing resources 1414 may include separate groupings of node C.R.s 1416 housed within one or more racks (not shown), or many racks housed in data centers at various geographical locations (also not shown). Separate groupings of node C.R.s 1416 within grouped computing resources 1414 may include grouped compute, network, memory or storage resources that may be configured or allocated to support one or more workloads. In at least one embodiment, several node C.R.s 1416 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1412 may configure or otherwise control one or more node C.R.s 1416(1)-1416(N) and/or grouped computing resources 1414. In at least one embodiment, resource orchestrator 1412 may include a software design infrastructure (SDI) management entity for the data center 1400. The resource orchestrator 1412 may include hardware, software, or some combination thereof.

In at least one embodiment, as shown in FIG. 14, framework layer 1420 may include a job scheduler 1433, a configuration manager 1434, a resource manager 1436, and/or a distributed file system 1438. The framework layer 1420 may include a framework to support software 1432 of software layer 1430 and/or one or more application(s) 1442 of application layer 1440. The software 1432 or application(s) 1442 may respectively include web-based service software or applications, such as those provided by Amazon Web Services, Google Cloud and Microsoft Azure. The framework layer 1420 may be, but is not limited to, a type of free and open-source software web application framework such as Apache Spark™ (hereinafter “Spark”) that may utilize distributed file system 1438 for large-scale data processing (e.g., “big data”). In at least one embodiment, job scheduler 1433 may include a Spark driver to facilitate scheduling of workloads supported by various layers of data center 1400. The configuration manager 1434 may be capable of configuring different layers such as software layer 1430 and framework layer 1420 including Spark and distributed file system 1438 for supporting large-scale data processing. The resource manager 1436 may be capable of managing clustered or grouped computing resources mapped to or allocated for support of distributed file system 1438 and job scheduler 1433. In at least one embodiment, clustered or grouped computing resources may include grouped computing resource 1414 at data center infrastructure layer 1410. The resource manager 1436 may coordinate with resource orchestrator 1412 to manage these mapped or allocated computing resources.

In at least one embodiment, software 1432 included in software layer 1430 may include software used by at least portions of node C.R.s 1416(1)-1416(N), grouped computing resources 1414, and/or distributed file system 1438 of framework layer 1420. One or more types of software may include, but are not limited to, Internet web page search software, e-mail virus scan software, database software, and streaming video content software.

In at least one embodiment, application(s) 1442 included in application layer 1440 may include one or more types of applications used by at least portions of node C.R.s 1416(1)-1416(N), grouped computing resources 1414, and/or distributed file system 1438 of framework layer 1420. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1434, resource manager 1436, and resource orchestrator 1412 may implement any number and type of self-modifying actions based on any amount and type of data acquired in any technically feasible fashion. Self-modifying actions may relieve a data center operator of data center 1400 from making possibly bad configuration decisions and possibly avoiding underutilized and/or poor performing portions of a data center.

The data center 1400 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1400. In at least one embodiment, trained or deployed machine learning models corresponding to one or more neural networks may be used to infer or predict information using resources described above with respect to the data center 1400 by using weight parameters calculated through one or more training techniques, such as but not limited to those described herein.

In at least one embodiment, the data center 1400 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1300 of FIG. 13—e.g., each device may include similar components, features, and/or functionality of the computing device(s) 1300. In addition, where backend devices (e.g., servers, NAS, etc.) are implemented, the backend devices may be included as part of a data center 1400, an example of which is described in more detail herein with respect to FIG. 14.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1300 described herein with respect to FIG. 13. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A: A method comprising: obtaining one or more automatically generated labels for one or more first sensor representations, the one or more automatically generated labels being determined using one or more machine learning models; generating, based at least on one or more first user inputs associated with the one or more automatically generated labels, one or more first human labels for the one or more first sensor representations; generating, based at least on one or more second user inputs, one or more second human labels for one or more second sensor representations; determining one or more consensus labels based at least on the one or more second human labels; and determining, based at least on the one or more first human labels and the one or more consensus labels, one or more values for one or more metrics associated with the one or more first human labels.

B: The method of paragraph A, wherein the determining the one or more values for the one or more metrics comprises: comparing the one or more first human labels to the one or more consensus labels; determining, based at least on the comparing, one or more errors associated with the one or more first human labels; and determining, based at least on the one or more errors, the one or more values for the one or more metrics associated with the one or more first human labels.

C: The method of paragraph A or paragraph B, wherein the generating the one or more consensus labels comprises generating the one or more consensus labels based at least on one or more of: computing one or more averages associated with the one or more second human labels; computing one or more modes associated with the one or more second human labels; computing one or more medians associated with the one or more second human labels; or computing one or more amounts of overlap associated with the one or more second human labels.

D: The method of any one of paragraphs A-C, further comprising: determining, based at least on the one or more values for the one or more metrics, a first score associated with an accuracy of training data that includes at least a portion of the one or more first sensor representations; determining a second score associated with one or more product requirements corresponding to the training data; and determining, based at least on the first score and the second score, whether the training data satisfies the one or more product requirements.

E: The method of any one of paragraphs A-D, further comprising determining, based at least on the one or more values for the one or more metrics, at least one of: a first evaluation associated with a user that provided at least a portion of the one or more first user inputs; or a second evaluation associated with a group of users that provided the one or more first user inputs.

F: A system comprising: one or more processors to: generate first data representative of one or more first labels associated with one or more first sensor representations; generate, based at least on one or more user inputs, second data representative of one or more second labels associated with one or more second sensor representations that correspond to the one or more first sensor representations; and determine, based at least on the one or more second labels, one or more values for one or more metrics associated with the one or more first labels.

G: The system of paragraph F, wherein the one or more processors are further to: obtain third data representative of one or more third labels associated with the one or more first sensor representations, the one or more third labels being determined using one or more machine learning models; and receive one or more second inputs associated with the one or more third labels, wherein the generation of the first data is based at least on the one or more second inputs.

H: The system of paragraph G, wherein the one or more second inputs indicate one or more of: that a first label of the one or more third labels is accurate; an update to a second label of the one or more third labels; that a third label of the one or more third labels needs to be removed; or that the one or more third labels is missing a fourth label.

I: The system of any one of paragraphs F-H, wherein the one or more processors are further to: generate one or more third labels based at least on the one or more second labels, wherein the determination of the one or more values for the one or more metrics is based at least on the one or more third labels.

J: The system of paragraph I, wherein the generation the one or more third labels comprises generating the one or more third labels based at least on one or more of: computing one or more averages associated with the one or more second labels; computing one or more modes associated with the one or more second labels; computing one or more medians associated with the one or more second labels; or computing one or more amounts of overlap associated with the one or more second labels.

K: The system of any one f paragraphs F-J, wherein the determination of the one or more values for the one or more metrics comprises: determining, based at least on the one or more second labels, one or more errors associated with the one or more first labels; and determining, based at least on the one or more errors, the one or more values for the one or more metrics associated with the one or more first labels.

L: The system of paragraph K, wherein the one or more errors are associated with at least one of: a first object represented by the one or more first sensor representations not including a first label from the one or more first labels; a second object represented by the one or more first sensor representations including a second label from the one or more second labels that is inaccurate; or a third object represented by the one or more first sensor representations not including a third label from the one or more first labels.

M: The system of any of paragraphs F-L, wherein the one or more processors are further to generate the one or more second sensor representations based at least on replicating the one or more first sensor representations.

N: The system of any one of paragraphs F-M, wherein the one or more processors are further to: determine that at least a portion of the one or more values for the one or more metrics are associated with a user; and determining, based at least on the portion of the one or more values of the one or more metrics, a score indicating an accuracy associated with the user.

O: The system of any one of paragraphs F-N, wherein the one or more processors are further to: determine that at least a portion of the one or more values for the one or more metrics are associated with a group of users; and determining, based at least on the portion of the one or more values of the one or more metrics, a score indicating an accuracy associated with the group of users.

P: The system of any one of paragraphs F-O, wherein the one or more processors are further to: determine, based at least on the one or more values for the one or more metrics, a first score associated with a first accuracy of training data that includes at least a portion of the one or more first sensor representations; determine a second score associated a second accuracy corresponding to one or one or more machine learning models; and determining, based at least on the first score and the second score, whether the training data satisfies the second accuracy corresponding to the one or more machine learning models.

Q: The system of paragraph P, wherein the determination of the second score comprises: determining, based at least on one or more product requirements corresponding to the one or more machine learning models, one or more second values associated with the second accuracy; and determining the second score based at least on the one or more second values.

R: The system of any one of paragraphs F-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to generate first data representing an evaluation associated with one or more first labels corresponding to one or more first sensor representations, wherein the first data is generated based at least on comparing the one or more first labels to one or more second labels corresponding to one or more second sensor representations as determined using one or more user inputs.

T: The one or more processors of paragraph S, wherein the one or more processors is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

Any, some and/or all features in one aspect of the disclosure may be applied to other aspects of the disclosure, in any appropriate combination or sub-combination. In particular, device aspects may be applied to method aspects, and vice versa. It should also be appreciated that particular combinations of the various features described and defined in any aspect or embodiment of the disclosure can be implemented and/or supplied and/or used independently.

The various features described in the description as optional—such as by use of “may” or “can”—may be combined into a single embodiment, and/or any combination of the features may be combined to form various embodiments that rely on the combination of these various optional features.

What is claimed is:

1. A method comprising:
obtaining one or more automatically generated labels for one or more first sensor representations, the one or more automatically generated labels being determined using one or more machine learning models;
generating, based at least on one or more first user inputs associated with the one or more automatically generated labels, one or more first human labels for the one or more first sensor representations;
generating, based at least on one or more second user inputs, one or more second human labels for one or more second sensor representations;
determining one or more consensus labels based at least on the one or more second human labels; and
determining, based at least on the one or more first human labels and the one or more consensus labels, one or more values for one or more metrics associated with the one or more first human labels.

2. The method of claim 1, wherein the determining the one or more values for the one or more metrics comprises:
comparing the one or more first human labels to the one or more consensus labels;
determining, based at least on the comparing, one or more errors associated with the one or more first human labels; and
determining, based at least on the one or more errors, the one or more values for the one or more metrics associated with the one or more first human labels.

3. The method of claim 1, wherein the generating the one or more consensus labels comprises generating the one or more consensus labels based at least on one or more of:
computing one or more averages associated with the one or more second human labels;
computing one or more modes associated with the one or more second human labels;
computing one or more medians associated with the one or more second human labels; or
computing one or more amounts of overlap associated with the one or more second human labels.

4. The method of claim 1, further comprising:
determining, based at least on the one or more values for the one or more metrics, a first score associated with an accuracy of training data that includes at least a portion of the one or more first sensor representations;
determining a second score associated with one or more product requirements corresponding to the training data; and
determining, based at least on the first score and the second score, whether the training data satisfies the one or more product requirements.

5. The method of claim 1, further comprising determining, based at least on the one or more values for the one or more metrics, at least one of:
a first evaluation associated with a user that provided at least a portion of the one or more first user inputs; or
a second evaluation associated with a group of users that provided the one or more first user inputs.

6. A system comprising:
one or more processors to:
generate first data representative of one or more first labels associated with one or more first sensor representations;
generate, based at least on one or more user inputs, second data representative of one or more second labels associated with one or more second sensor representations that correspond to the one or more first sensor representations; and
determine, based at least on the one or more second labels, one or more values for one or more metrics associated with the one or more first labels.

7. The system of claim 6, wherein the one or more processors are further to:
obtain third data representative of one or more third labels associated with the one or more first sensor representations, the one or more third labels being determined using one or more machine learning models; and
receive one or more second inputs associated with the one or more third labels,
wherein the generation of the first data is based at least on the one or more second inputs.

8. The system of claim 7, wherein the one or more second inputs indicate one or more of:
that a first label of the one or more third labels is accurate;
an update to a second label of the one or more third labels;
that a third label of the one or more third labels needs to be removed; or
that the one or more third labels is missing a fourth label.

9. The system of claim 6, wherein the one or more processors are further to:
generate one or more third labels based at least on the one or more second labels,
wherein the determination of the one or more values for the one or more metrics is based at least on the one or more third labels.

10. The system of claim 9, wherein the generation the one or more third labels comprises generating the one or more third labels based at least on one or more of:
computing one or more averages associated with the one or more second labels;
computing one or more modes associated with the one or more second labels;
computing one or more medians associated with the one or more second labels; or
computing one or more amounts of overlap associated with the one or more second labels.

11. The system of claim 6, wherein the determination of the one or more values for the one or more metrics comprises:
determining, based at least on the one or more second labels, one or more errors associated with the one or more first labels; and
determining, based at least on the one or more errors, the one or more values for the one or more metrics associated with the one or more first labels.

12. The system of claim 11, wherein the one or more errors are associated with at least one of:
a first object represented by the one or more first sensor representations not including a first label from the one or more first labels;
a second object represented by the one or more first sensor representations including a second label from the one or more second labels that is inaccurate; or
a third object represented by the one or more first sensor representations not including a third label from the one or more first labels.

13. The system of claim 6, wherein the one or more processors are further to generate the one or more second sensor representations based at least on replicating the one or more first sensor representations.

14. The system of claim 6, wherein the one or more processors are further to:
determine that at least a portion of the one or more values for the one or more metrics are associated with a user; and
determining, based at least on the portion of the one or more values of the one or more metrics, a score indicating an accuracy associated with the user.

15. The system of claim 6, wherein the one or more processors are further to:
determine that at least a portion of the one or more values for the one or more metrics are associated with a group of users; and
determining, based at least on the portion of the one or more values of the one or more metrics, a score indicating an accuracy associated with the group of users.

16. The system of claim 6, wherein the one or more processors are further to:
determine, based at least on the one or more values for the one or more metrics, a first score associated with a first accuracy of training data that includes at least a portion of the one or more first sensor representations;
determine a second score associated a second accuracy corresponding to one or one or more machine learning models; and
determining, based at least on the first score and the second score, whether the training data satisfies the second accuracy corresponding to the one or more machine learning models.

17. The system of claim 16, wherein the determination of the second score comprises:
determining, based at least on one or more product requirements corresponding to the one or more machine learning models, one or more second values associated with the second accuracy; and
determining the second score based at least on the one or more second values.

18. The system of claim 6, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to generate first data representing an evaluation associated with one or more first labels corresponding to one or more first sensor representations, wherein the first data is generated based at least on comparing the one or more first labels to one or more second labels corresponding to one or more second sensor representations as determined using one or more user inputs.

20. The one or more processors of claim 19, wherein the one or more processors is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
